(19) United States
(12) Patent Application Publication
(10) Pub. No.: US 2026/0320400 A1
(43) Pub. Date: Oct. 15, 2026

(54) HIERARCHICAL FOUNDATION MODEL

(71) Applicant: Mellanox Technologies Ltd., Yokneam (IL)

(72) Inventors: Yoli Shavit, Kibbutz Naan (IL); Guy Zohar, Even Yehuda (IL); Hanan Shteingart, Herzliya (IL); Yaarit Lotan, Haifa (IL); Jean-Philippe Vasseur, Combloux (FR); Zachi Binshtock, Hod Hasharon (IL)

(21) Appl. No.: 19/177,375

(22) Filed: Apr. 11, 2025

(51) Int. Cl. G06N 3/0895; G06N 3/045

(52) U.S. Cl. CPC G06N 3/0895; G06N 3/045

(57) ABSTRACT

Apparatuses, systems, methods, and techniques to use machine learning processes (e.g., neural networks) arranged hierarchically to generate at least one latent representation of two or more input data streams. In at least one embodiment, one or more tasks are performed based, at least in part, on the at least one latent representation.

### TECHNICAL FIELD

At least one embodiment pertains to a plurality of neural networks that generate latent representations of data streams transmitting multimodal data, multivariate data, multicomponent data, and/or multisource data. In at least one embodiment, the plurality of neural networks are components of a foundation model that may be pre-trained to encode data from the data streams, and fine-tuned to perform specific tasks. In at least one embodiment, the plurality of neural networks are arranged hierarchically to align and merge the data streams to generate the latent representations. In at least one embodiment, a computing system (e.g., within a data center) implements various novel techniques described herein.

### BACKGROUND

Data centers process and/or generate large quantities of data. For example, data related to one or more devices within a data center (e.g., logs, telemetry data, etc.) may be transmitted within the data center in data streams. The data transmitted by such data streams may encompass a variety of formats, include different values for various parameters, be collected at different times, be collected at different frequencies, and/or use different units of measure. This heterogeneity with respect to the data streams may make them difficult to aggregate and/or analyze. Techniques for managing and analyzing data collected at a data center can be improved.

### BRIEF DESCRIPTION OF DRAWINGS

FIG. 1 is a block diagram illustrating an example architecture that may be used to construct a data center, in accordance with at least one embodiment;

FIG. 2A is a block diagram illustrating an example of a tree foundation model (FM) having a hierarchical structure, in accordance with at least one embodiment;

FIG. 2B is a block diagram illustrating a plurality of tree FMs arranged to produce output, in accordance with at least one embodiment;

FIG. 3A illustrates a block diagram illustrating an example data structure, in accordance with at least one embodiment;

FIG. 3B illustrates a block diagram illustrating an inference process performed by a leaf FM of the tree FM of FIG. 2A, in accordance with at least one embodiment;

FIG. 3C illustrates a block diagram illustrating an inference process performed by a FM node of the tree FM of FIG. 2A that may be other than a leaf FM, in accordance with at least one embodiment;

FIG. 4 illustrates a block diagram depicting a training process, in accordance with at least one embodiment;

FIG. 5 is a flow diagram illustrating a method of using a hierarchical FM, in accordance with at least one embodiment;

FIG. 6 is a flow diagram illustrating a training method that may be used to train a leaf FM of a hierarchical FM, in accordance with at least one embodiment;

FIG. 7 is a flow diagram illustrating a training method that may be used to train a FM node of a hierarchical FM, in accordance with at least one embodiment;

FIG. 8 illustrates an example of a system that includes a driver and/or runtime including one or more libraries to provide one or more application programming interfaces (APIs), in accordance with at least one embodiment;

FIG. 9 is a block diagram illustrating an example of a processor and storage, according to at least one embodiment;

FIG. 10A illustrates logic, according to at least one embodiment;

FIG. 10B illustrates logic, according to at least one embodiment;

FIG. 11 illustrates an example data center system, according to at least one embodiment; and

FIG. 12 is a block diagram illustrating a computer system, according to at least one embodiment.

### DETAILED DESCRIPTION

In preceding and following descriptions, various techniques are described. For purposes of explanation, specific configurations and details are set forth in order to provide a thorough understanding of possible ways of implementing techniques. However, it will also be apparent that techniques described below may be practiced in different configurations without specific details. Furthermore, well-known features may be omitted or simplified to avoid obscuring techniques being described.

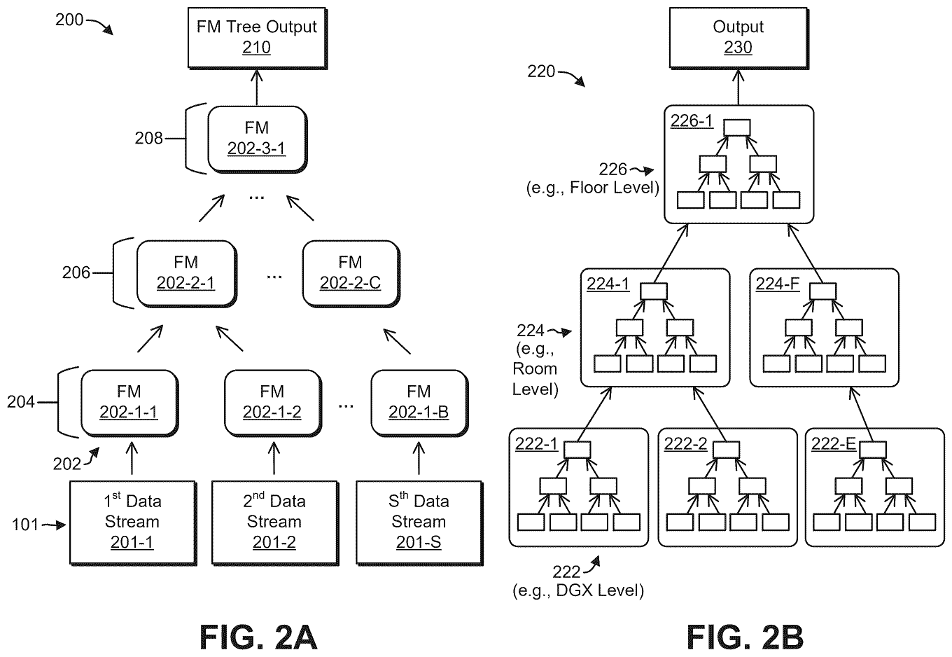

A foundation model (FM) is a machine learning model that may provide a “foundation” from which more specialized models may be generated. FMs may be pre-trained on general data and then fine-tuned for specific applications. A hierarchical FM (e.g., a tree FM 200 illustrated in FIG. 2A) may be used to generate a latent representation (e.g., a sequence of vectors) representing a combination of different data streams, which transmit different data. This latent representation may then be used to perform one or more analyses, which may be characterized as being performed on the different data streams simultaneously.

The hierarchical FM may have a hierarchical structure that includes nodes (referred to as FM nodes) arranged in one or more layers. Each of the FM nodes is a separate and individual FM, and the hierarchical FM may be characterized as being an aggregation or a combination of the individual FMs. The layers may be described as being stacked atop one another such that some layers are above other layers. However, such a stacked arrangement is for merely for illustrative and descriptive purposes and is not a requirement of the hierarchical FM. Each layer includes one or more FM nodes.

Data stream(s) may be received at and/or generated by a data center, and provided to at least some of the individual FM nodes of the hierarchical FM. Within the hierarchical FM, any FM nodes that do not receive output from a previous FM node in the same hierarchical FM are referred to as a leaf FM. Each of the leaf FM may receive a single data stream as an input. In the hierarchical FM, the output of a leaf FM, which may be characterized as being a parent node, may be input into one or more FM nodes, which may be characterized as being child node(s) with respect to the leaf FM. In the hierarchical FM, the output of two or more of the leaf FMs may be provided to another FM node, which may align and/or fuse the output to generate a combined latent representation that may be provided to another FM node and/or used to perform one or more tasks (e.g., pattern identification, forecasting, and/or anomaly detection). The output of another hierarchical FM may be provided as input to a leaf FM or to a FM node that is not a leaf FM. When particular output of another hierarchical FM is provided to a particular FM node that is not a leaf FM, that particular output may be combined by the particular FM node with output of an FM (e.g., a leaf or an FM node that is not a leaf FM) of the hierarchical FM. The hierarchical FM may be trained in a self-supervised manner on the different data streams, such as multivariate, multisource, multimodal, and/or multicomponent data streams, to align and/or fuse data from the different data streams.

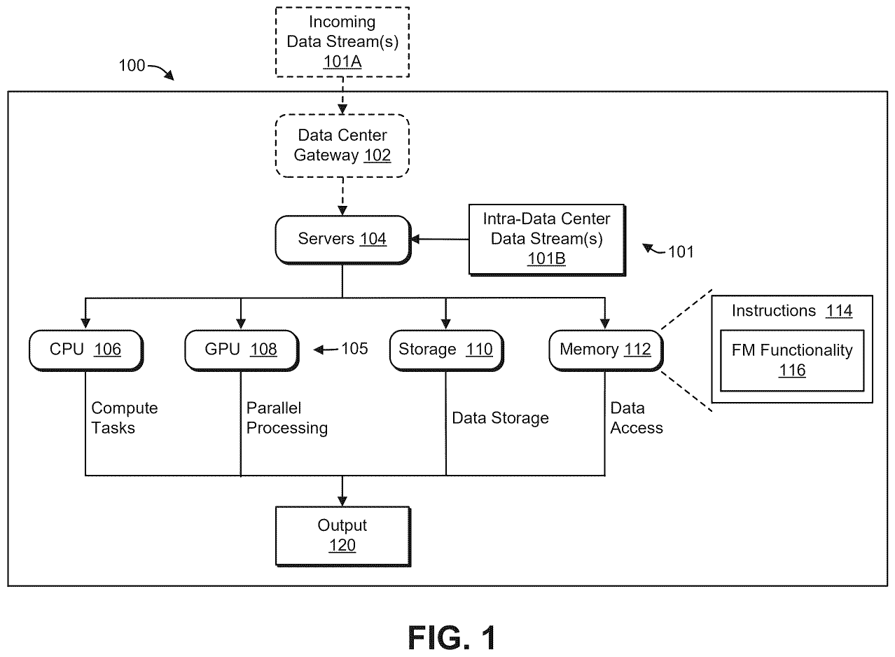

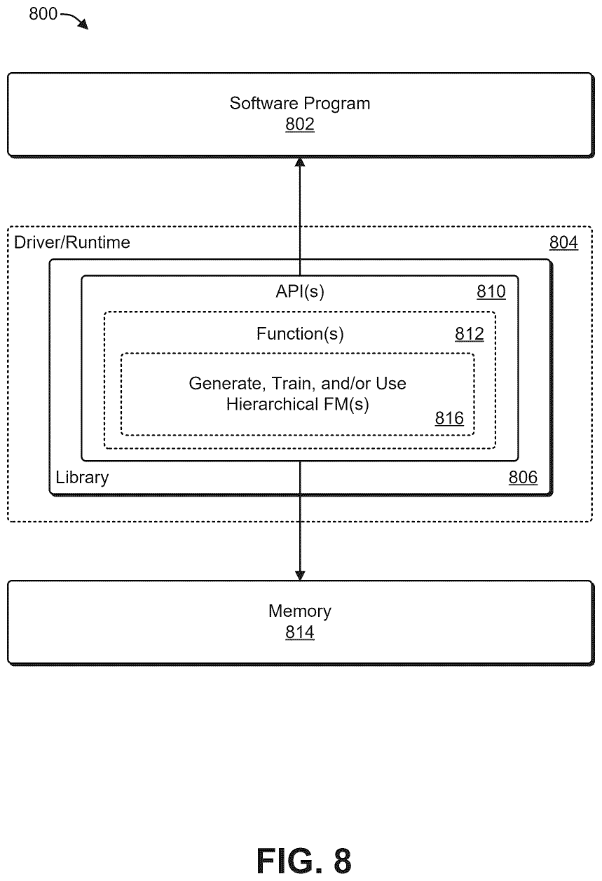

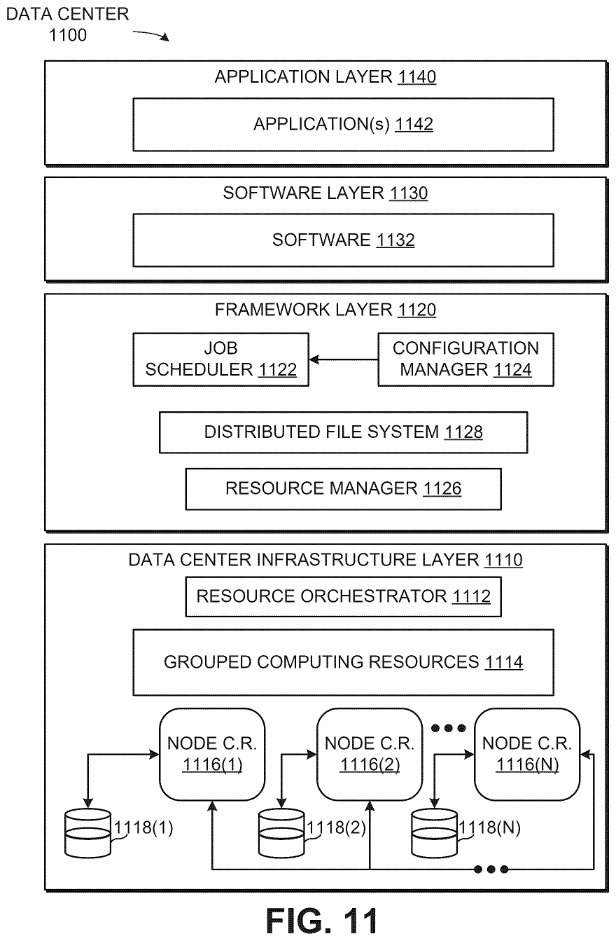

FIG. 1 is a block diagram illustrating an example architecture that may be used to construct a data center 100, in accordance with at least one embodiment. The data center 100 may include a variety of software and hardware for processing, storage, management, and dissemination of data and information. The data center 100 may include an artificial intelligence (AI) Factory Data Center, or other specialized data center designed to support the computational needs of AI applications. Details regarding one or more components that may be included in the data center 100 are provided further below with reference to FIG. 11. In at least one embodiment, at least a portion of the data center 100 is implemented using at least a portion of any system(s) depicted in and/or described with respect to FIGS. 8-12. In at least one embodiment, at least a portion of the data center 100 is used to implement at least a portion of any system(s) depicted in and/or described with respect to FIGS. 8-12.

In at least one embodiment, the data center 100 processes one or more data streams 101. The data stream(s) 101 may include a continuous flow of data that may be generated and/or transmitted in real-time. Each of the data stream(s) 101 may consist of a sequence of data elements that may be produced over a time period (e.g., continuously), such as by one or more sensors, one or more monitors, one or more data collection processes (e.g., implemented by software and/or hardware), and/or one or more other data collection methods. Each of the data elements may have a data format, such as structured, semi-structured, or unstructured format. The data stream(s) 101 may be processed (e.g., in real-time or at near-real-time) to extract useful information and/or insights, which may enable timely decision-making and/or actions to be performed in response to the information and/or insights.

The data stream(s) 101 may include one or more incoming data streams 101A and/or one or more intra-data center data streams 101B. The incoming data stream(s) 101A is/are received from one or more data sources external to the data center 100. For example, the incoming data stream(s) 101A may be received at the data center 100 from one or more computing devices, such as one or more personal computing devices, one or more Internet of Things (IoT) devices, one or more wearable devices (e.g., an augmented reality (AR) headset, a virtual reality (VR) headset, a mixed reality headset, and/or other wearable devices), one or more vehicles, and/or one or more other types of devices. The intra-data center data stream(s) 101B originate inside the data center 100. For example, the intra-data center data stream(s) 101B may be transmitted to one or more of the server(s) 104 from another component inside the data center 100. For example, one of the server(s) 104 may transmit one or more of the intra-data center data stream(s) 101B to another of the server(s) 104. The intra-data center data stream(s) 101B may be both transmitted and processed by the same server (e.g., one of the server(s) 104). For example, one or more devices of a particular one of the server(s) 104 may generate the intra-data center data stream(s) 101B, and the particular server may process the data stream(s) transmitted by those device(s).

Data transmitted by the data stream(s) 101 may include data such as user-generated content from web applications, sensor data, transactional data, multimedia content, and/or one or more other types of content. The data transmitted by the data stream(s) 101 may include telemetry data, log data, time series data, structured data, semi-structured data, unstructured data, and/or one or more other types of data. In at least one embodiment, the data stream(s) 101 may include multimodal data, multivariate data, multicomponent data, and/or multisource data.

Multimodal data is heterogeneous, assigned multiple data types, and/or stored using multiple data formats. Multimodal data includes data having two or more modalities. Different modalities may be captured using different mechanisms (e.g., using different sensors and/or different methods). Different modalities may provide one or more different types of information. For example, modalities can include text data, audio data, image data, video data, sensor data, spatial data, temporal data, haptic data, and/or one or more other types of data. With respect to the data center 100, examples of multimodal data may include logs, configuration files, packet analysis results, central processing unit (CPU) usage metrics, memory usage metrics, disk I/O metrics, telemetry data, and/or sensor data (e.g., collected by temperature sensors, humidity sensors, power usage sensors, surveillance cameras, thermal imaging devices, environmental noise sensors, traffic flow sensors, rack layout sensors, equipment layout sensors, and/or other types of sensors). A more comprehensive understanding of a complex phenomena and/or a situation may be obtained by integrating and analyzing multimodal data (e.g., using foundation model (FM) functionality 116). The FM functionality 116 may be used to fuse multimodal data for processing by machine learning process(es) and/or one or more artificial intelligences (AI(s)).

Multivariate data includes values corresponding to multiple variables (e.g., one or more parameters, or one or more features). Each observation in a multivariate dataset includes a value for more than one variable. With respect to the data center 100, examples of multivariate data may include CPU usage metrics, memory usage metrics, disk I/O metrics, traffic flow metrics, connection metrics, telemetry data, temperature data, humidity data, power consumption metrics, energy efficiency data, logs (e.g., access logs, alert logs, and/or others), surveillance data, equipment status data, and/or other data. Multivariate data may be used to analyze complex relationships and/or interactions between the variables. The FM functionality 116 may be used to align and/or fuse multivariate data for processing (e.g., analysis) by machine learning process(es) and/or AI(s). By analyzing multivariate data, patterns, correlations, and/or trends may be identified in the data that are not apparent when analyzing each of the variables in isolation.

Multicomponent data includes metrics collected with respect to multiple components. Components may include one or more devices (e.g., individual GPUs), one or more groupings of the device(s) (e.g., a deep learning system that includes the individual GPUS), one or more software processes, one or more groupings of the software process(es), and/or other types of components.

Multisource data includes data categorized into one or more source categories. By way of a non-limiting example, source categories may include “compute,” “networking,” and/or others. Data categorized in the “compute” category may have been collected with respect to a component that performs computation (e.g., a processor, a GPU, a CPU, etc.) and/or may otherwise relate to computation (e.g., GPU utilization metrics). Data categorized in the “networking” category may have been collected with respect to a component that performs networking (e.g., a router, a network interface controller, etc.) and/or may otherwise relate to networking (e.g., quality of service, signal-to-noise ratio, bandwidth utilization metrics, network latency metrics, etc.).

For example, the data transmitted by the data stream(s) 101 may have different formats, include values for different parameters, be collected at different times, be collected at different frequencies, include values for the same parameters collected using different units of measure, etc. The diversity of the data transmitted in the data stream(s) 101 may be ingested, processed (e.g., by the FM functionality 116), and/or stored at or by the data center 100 for subsequent analysis and/or utilization (e.g., by machine learning process(es) and/or AI(s)).

In embodiments that include the incoming data stream(s) 101A, the incoming data stream(s) 101A may be received at a data center gateway 102. For example, the data center gateway 102 may include hardware (and associated software) to receive and distribute data received in the incoming data stream(s) 101A to other components of the data center 100. The hardware of the data center gateway 102 may include, as non-limiting examples, one or more network interface cards (NICs) to facilitate reception and transmission of data packets, one or more routers and/or switches to manage data flow between external sources of the data stream(s) 101 and internal components of the data center 100, one or more firewalls to filter the incoming data stream(s) 101A to prevent unauthorized access, load balancers to distribute incoming data traffic with regard to one or more server(s) 104, and/or one or more other hardware components. In at least one embodiment, at least a portion of the data center gateway 102 is implemented using at least a portion of any system(s) depicted in and/or described with respect to FIGS. 8-12. In at least one embodiment, at least a portion of the data center gateway 102 is used to implement at least a portion of any system(s) depicted in and/or described with respect to FIGS. 8-12. Some embodiments may omit the incoming data stream(s) 101A, and such embodiments may also omit the data center gateway 102.

In at least one embodiment, the server(s) 104 may be implemented as one or more computing devices that host applications and/or provide services to end-users. For example, the server(s) 104 may be equipped with one or more processors 105, storage 110, and/or memory 112. The processor(s) 105 may include one or more CPUs 106, one or more graphics processing units (GPU(s)) 108, one or more parallel processing units (PPU(s)), a main central processing unit (“CPU”) complex, one or more microprocessors, one or more microcontrollers, one or more data processing units (“DPU(s)”), one or more arithmetic logic units (“ALU(s)”), and/or one or more other types of processors. In at least one embodiment, at least a portion of the processor(s) 105 is implemented using at least a portion of any system(s) depicted in and/or described with respect to FIGS. 8-12. In at least one embodiment, at least a portion of the processor(s) 105 is used to implement at least a portion of any system(s) depicted in and/or described with respect to FIGS. 8-12. In at least one embodiment, at least a portion of one or more of the server(s) 104 is implemented using at least a portion of any system(s) depicted in and/or described with respect to FIGS. 8-12. In at least one embodiment, at least a portion of one or more of the server(s) 104 is used to implement at least a portion of any system(s) depicted in and/or described with respect to FIGS. 8-12.

The server(s) 104 may manage diverse computational workloads. The server(s) 104 may be interconnected through a network infrastructure (e.g., a network internal to the data center 100) to facilitate communication and data exchange between different ones of the server(s) 104 and/or between the server(s) 104 and one or more other devices. The network infrastructure may include one or more networking devices (not shown), such as one or more switches, one or more firewalls, one or more hubs, one or more modems, one or more access points (AP(s)), one or more repeaters, one or more bridges, one or more gateways, one or more network interfaces (e.g., one or more Network Interface Controllers (NIC(s))), one or more load balancers, and/or one or more routers, that route data traffic within an internal network, for example, between the server(s) 104.

In at least one embodiment, the processor(s) 105 (e.g., the CPU(s) 106) perform(s) tasks, such as executing instructions, and/or performing one or more computations. For example, the CPU(s) 106 may process data by performing arithmetic and/or logic operations. The CPU(s) 106 may interface with other components of the server(s) 104 to coordinate performance of one or more tasks. For example, the CPU(s) 106 may provide instructions to the GPU(s) 108 to perform parallel processing of data. In at least one embodiment, the GPU(s) 108 accelerate performance of one or more tasks via parallel processing. As an example, the GPU(s) 108 may perform large-scale computations, such as those used for machine learning and data analytics. By utilizing the GPU(s) 108 in conjunction with the CPU(s) 106, computational efficiencies of the server(s) 104 may be increased.

In at least one embodiment, the storage 110 is a component of and/or is accessible by the server(s) 104 and performs data storage. For example, the storage 110 may include storage media, such as hard drives and solid-state drives, to provide high-capacity and high-seed data access. The storage 110 may maintain data integrity and support rapid data retrieval when data is requested for processing.

In at least one embodiment, the memory 112 is a component of and/or is accessible by the server(s) 104 and provides data access. For example, the memory 112 may include random-access memory (RAM) that facilitates rapid access to data, thereby enhancing a speed and efficiency of tasks performed at the data center 100. The memory 112 may be managed to optimize resource allocation and performance.

The storage 110 and/or the memory 112 may include one or more non-transitory machine readable media. The storage 110 and/or the memory 112 (e.g., non-transitory machine readable media) may store executable instructions 114 that if executed by one or more of the processor(s) 105 (e.g., one or more of the CPU(s) 106 and/or one or more of the GPU(s) 108) implement the FM functionality 116. The storage 110 and/or the memory 112 (e.g., one or more non-transitory processor-readable medium) may be implemented, for example, using volatile memory (e.g., dynamic random-access memory (“DRAM”)) and/or nonvolatile memory (e.g., a hard drive, a solid-state device (“SSD”), and/or the like). In at least one embodiment, at least a portion of the storage 110 and/or at least a portion of the memory 112 is/are each implemented using at least a portion of any system(s) depicted in and/or described with respect to FIGS. 8-12. In at least one embodiment, at least a portion of the storage 110 and/or at least a portion of the memory 112 is/are each used to implement at least a portion of any system(s) depicted in and/or described with respect to FIGS. 8-12.

The components of the server(s) 104 may be used to generate results of operations performed based on data processed at the server(s) 104. For example, one or more of the server(s) 104 may perform the FM functionality 116, which may produce results. In at least one embodiment, the results of the FM functionality 116 are provided as an output 120 (e.g., of the data center 100 and/or one or more of the server(s) 104). The output 120 may remain inside the data center 100 and/or may be sent to one or more receiving destinations. For example, the receiving destinations may include end-users and/or other systems. The data center 100, the server(s) 104, and/or one or more external devices that transmit the data steam(s) 101A to the data center 100 may perform various tasks in various environments, such as factories, healthcare facilities (e.g., hospitals), offices, households, vehicles, robots, warehouses, and/or any suitable context or environment. The data stream(s) 101 may include data related to performing such tasks, such as information related to computing resources used to perform the tasks. The data stream(s) 101 may include data related to performing machine learning tasks and/or one or more other computationally intensive tasks.

As discussed above, the data stream(s) 101 may include complex data having different modalities and/or including values for different variables and/or parameters. In at least one embodiment, the data transmitted in the data stream(s) 101 is collected and/or combined (e.g., aggregated) by one or more of the server(s) 104 for further processing. The FM functionality 116 may be used to aggregate two or more of the data stream(s) 101, for example transmitting multimodal data and/or multivariate data, and use the aggregated data to recognize and/or identify patterns in the data stream(s) 101. Identification of such patterns may be applied to tasks, such as predicting future events and/or detecting unusual activities (e.g., anomalies), which allow appropriate adjustments to be made to any affected systems (e.g., the data center 100, the server(s) 104, and/or other systems inside or outside the data center 100). By accurately identifying data patterns for downstream decision-making and/or detection of anomalies, performance of one or more systems, such as the data center 100, may be improved.

The FM functionality 116, if performed by at least one of the processor(s) 105 (e.g., at least one of the CPU(s) 106 and/or at least one of the GPU(s) 108), implements a hierarchical FM (e.g., a tree FM 200 illustrated in FIG. 2A) and uses the hierarchical FM to generate a latent representation (e.g., a sequence of vectors) representing a combination of different data streams (e.g., the data stream(s) 101), which transmit different data (e.g., multimodal data, multivariate data, multicomponent data, and/or multisource data). This latent representation (e.g., FM tree output 210 illustrated in FIG. 2A) may then be used to perform one or more analyses (e.g., using one or more machine learning processes, such as one or more neural networks) on the different data streams (e.g., the data stream(s) 101) simultaneously.

The data stream(s) 101 may be received at and/or generated by the data center 100, and provided to at least some of the individual FM nodes of the hierarchical FM. For example, the data stream(s) 101 may be provided to only a set of leaf FM on a first or lowest layer of the hierarchical FM. However, any layer of the hierarchical FM may include one or more leaf FM. Each leaf FM may process one or more data streams generated at one or more computing devices within the data center 100 (e.g., data streams generated by a GPU and/or NIC of a particular computing device).

FIG. 2A is a block diagram illustrating an example of a tree FM 200 having a hierarchical structure, in accordance with at least one embodiment. The FM functionality 116, if performed by at least one of the processor(s) 105 (e.g., at least one of the CPU(s) 106 and/or at least one of the GPU(s) 108), may implement the tree FM 200. The tree FM 200 includes a plurality of FM nodes 202 arranged in a hierarchical structure. The FM nodes 202 may be arranged in layers, such as layers 204-208, that may be described as being stacked atop one another such that some layers are above other layers. However, such a stacked arrangement is for merely for illustrative and descriptive purposes and is not a requirement of the tree FM 200. In the tree FM 200, each subsequent (e.g., sequentially higher) layer may include fewer FM nodes than a previous (e.g., lower) layer. However, this is not a requirement, and in some embodiments, one or more layers may include more FM nodes that at least one previous layer.

The tree FM 200 may include the first (e.g., bottom) layer 204, one or more intermediate layers (e.g., the intermediate layer 206), and the final (e.g., top) layer 208. However, the tree FM 200 may include any number of layers, including a single layer. For example, the tree FM 200 may omit the intermediate layer 206. Further, the tree FM 200 may include one or more layers above the final layer 208 and/or one or more layers below the first layer 204. For example, although only the single intermediate layer 206 is shown in FIG. 2A, the tree FM 200 may include any number of intermediate layers positioned between the first layer 204 and the final layer 208. Furthermore, the first layer 204, the intermediate layer 206, and/or the final layer 208 may include different quantities of the FM nodes 202 than those depicted in FIG. 2A. For example, the first layer 204, each of the intermediate layers (e.g., the intermediate layer 206), and/or the final layer 208 may each include any number of FM nodes 202, including a single FM node.

As mentioned herein, a FM node of the tree FM 200 that does not receive output from another FM node of the tree FM 200 as input, is referred to as a leaf FM. In FIG. 2A, the FM nodes 202-1-1 to 202-1-B are leaf FMs. In the tree FM 200, the output of the leaf FM(s), which may be characterized as being parent node(s), is input to one or more FM nodes, which may be characterized as being child node(s) with respect to the leaf FM(s). For example, in FIG. 2A, a FM node 202-2-1 is child node with respect to parent leaf FMs 202-1-1 and 202-1-2. Additionally, a FM node 202-2-2 is child node with respect to parent leaf FMs 202-1-B and possibly one or more other leaf FMs. By way of another non-limiting example, a FM node 202-3-1 is child node with respect to parent leaf FMs 202-2-1 and 202-2-C.

In at least one embodiment, each leaf FM of the first layer 204 receives one or more of the data stream(s) 101. For example, each leaf FM of the first layer 204 may receive a data stream from a particular computing device. By way of a non-limiting example, the leaf FM 202-1-1 of the first layer 204 may receive a first data stream 201-1, the leaf FM 202-1-2 may receive a second data stream 201-2, and the leaf FM 202-1-B of the first layer 204 may receive an Sth data stream 201-S. Each the leaf FM of the first layer 204 may generate a latent representation of its respective incoming data stream and that latent representation may be an input to the FM nodes of the intermediate layer 206. For example, output from the leaf FM 202-1-1 and the leaf FM 202-1-2 may both be provided to the FM node 202-2-1 of the intermediate layer 206. Further, output from the leaf FM 202-1-B and possibly at least one other FM node of the first layer 204 may be provided to the FM node 202-2-C of the intermediate layer 206. By way of a non-limiting example, the data output from the first layer 204 may include a latent representation (e.g., an encoding) of multivariate intra-device data, which may be provided to the FM nodes of the intermediate layer 206 for further processing.

In at least some embodiments, each leaf FM of the first layer 204 may generate a latent representation of data from a single type of data stream and/or data streams originating from a single source. For example, the first data stream 202-1 received by the FM node 202-1-1 may include multivariate time series data from a Data Center GPU Manager (DCGM) of a specific GPU, the second data stream 202-2 received the FM node 202-1-2 may include kernel syslogs data, which may be semi-structured data generated by that same GPU, and the Sth data stream 202-S received at the FM node 202-1-B may include another type of data from that same GPU.

The FM nodes of the intermediate layer 206 may align and/or fuse data (e.g., latent representations) received from two of more leaf FMs of the first layer 204, and generate latent representations of the aligned and/or fused data. The latent representations output by the FM nodes of the intermediate layer 206 may be input into one or more of the FM nodes 202 which are on the final layer 208. Data output by the intermediate layer 206 may include, for example, multimodal, multisource, and intra-device data, which may be received at the final layer 208 for final processing.

In the example illustrated in FIG. 2A, the FM node 202-3-1 of the final layer 208 may align and/or fuse data received from the intermediate layer 206, and generate one or more latent representations of the aligned and/or fused data. The FM node 202-3-1 of the final layer 208 may obtain data from other tree FMs, align and/or fuse the obtained data with the data received from the intermediate layer 206, and generate one or more latent representations of the aligned and/or fused data.

In at least one embodiment, the structure of the tree FM 200 (e.g., edges connecting nodes) may be determined based on 1) prior knowledge and/or 2) learning. When the structure is determined based on prior knowledge, the FM nodes 202 may be interconnected according to logic defined at least in part by the prior knowledge. As an example, a hierarchy of the layers of the tree FM 200 may be structured based on domain knowledge. When the tree FM 200 structure is determined based on prior knowledge, the one or more intermediate layers (e.g., the intermediate layer 206) may include one or more of the FM nodes 202 that receive data from at least a portion (e.g., two or more) of the FM nodes of the first layer 204. In at least one embodiment, the FM nodes of the intermediate layer 206 may align latent representations received from the FM nodes of the first layer 204 based on one or more variables, such as time. The FM nodes of the intermediate layer 206 may further fuse or merge the latent representations received from the first layer 204, each latent representation representing a different data stream. For example, the FM node 202-1-1 may generate DCGM encodings from the first data stream 202-1, the FM node 202-1-2 may generate syslog encodings from the second data stream 202-2 (e.g., transmitting a syslog collected with respect to a deep learning system, such as DGX), and the FM node 202-2-1 may align the DCGM encodings with the syslog encodings based on a device identifier (e.g., DGX ID) and one or more defined time periods. The FM node 202-2-1 may combine and/or fuse these aligned latent representations by, for example summing the aligned latent representations, concatenating the aligned latent representations, and/or providing the aligned latent representations as input to a trained linear layer to generate a fused latent representation. Then, the FM functionality 116 may provide the fused latent representation to one or more neural networks (e.g., a transformer encoder) as input to produce a latent representation as output. The latent representation may be used as input to another FM node and/or another process. For example, the FM node 202-3-1 may receive the latent representation as input. The latent representation may represent DCGM data and syslogs for a group of hosts (e.g., a group of deep learning systems), clustered by some aspect (i.e. the room they are in, in the data center 100). The FM node 202-3-1 may aggregate across the axis or D dimension of hosts (e.g., deep learning systems).

Latent representations output by the intermediate layer 206 may be clustered based on one or more aspects (such as a room where the computing devices are located in the data center 100) and one or the FM nodes 202 may be created for each cluster at the final layer 208 of the tree FM 200. In at least one embodiment, a FM node (e.g., a FM node 202-3-1) of the final layer 208 receives the output of two or more FM nodes of the intermediate layer 206 (e.g., the FM node 202-2-1 and the FM node 202-2-M) within a cluster and aligns and/or fuses that output. The final layer 208 may combine or fuse the outputs by, for example by summing the outputs, concatenating the outputs, and/or providing the outputs as input to a trained linear layer to generate a fused latent representation. Then, the FM functionality 116 may provide the fused latent representation to one or more neural networks (e.g., a transformer encoder) as input to produce a latent representation as output.

For example, the FM functionality 116 may connect any FM nodes on the first layer 204 that process telemetry associated with compute (e.g. DCGM, Syslogs) to a first FM node of the intermediate layer 206, and the FM functionality 116 may separately connect any FM nodes on the first layer 204 that process telemetry associated with networking (e.g. CollectX, SM logs) to a different second FM node of the intermediate layer 206. Alternatively, the FM functionality 116 may first use the FM nodes of the intermediate layer 206 to aggregate the FM nodes of the first layer 204 by a modality type (time series versus logs) of the data streams processed by the FM nodes. Then, the FM functionality 116 may use the FM nodes of a higher adjacent layer (e.g., the final layer 208) to aggregate the FM nodes of the intermediate layer 206 by values of the variable “source” (e.g., “compute” or “networking”).

In some embodiments, when the structure of the tree FM 200 is determined based on learning, at least a portion of the structure of the tree FM 200 may be created based on grouping the FM nodes 202 according to a neural architecture search (NAS). For example, the FM functionality 116 may specify a number of FM nodes included in each layer, other than the first layer 204, and determine how to group the FM nodes of the adjacent lower level (or connect the FM nodes of the adjacent lower level to the FM nodes of the upper layer) using one or more NAS algorithms. The number of FM nodes on the first layer 204 may be determined at least in part by the number of data stream(s) 101.

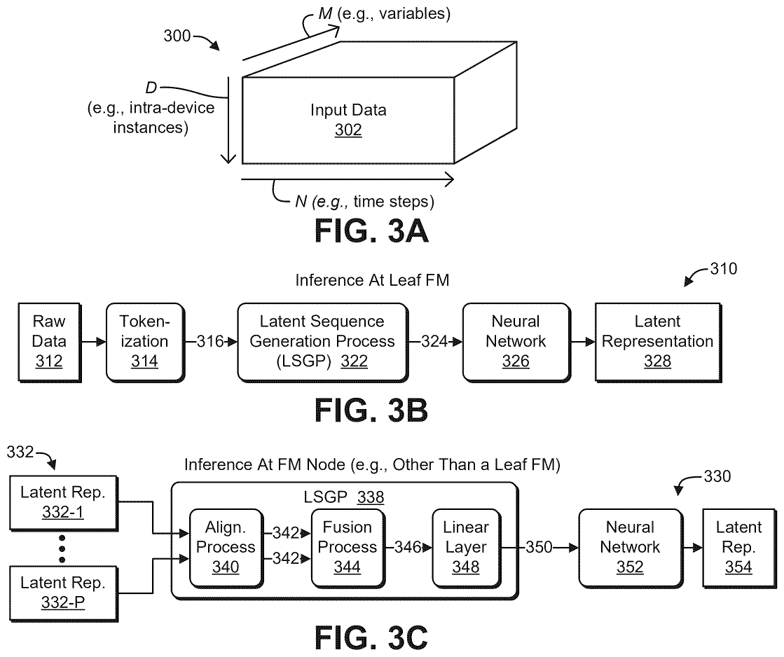

By way of another non-limiting example, the FM functionality 116 may use NAS to identify an architecture for each of the FM nodes 202 according to a task that the FM node is to perform. To form the first layer 204 of the tree FM 200, FM nodes having similar architectures and/or assigned similar tasks may be selected and arranged as the first layer 204. For example, as described above, the FM nodes of the first layer 204 may have neural architectures configured to receive a single data stream type and output a latent representation of data from the data stream. The FM nodes of the one or more intermediate layers (e.g., the intermediate layer 206) may have neural architectures configured to receive two or more latent representations of different data types, align and/or fuse the latent representations, and output a latent representation of the aligned and/or fused data. The FM nodes of the final layer 208 may be determined by grouping the output of two or more FM nodes 202 of the previous intermediate layer (e.g., the intermediate layer 206) based on computed soft clustering. For example, the outputs may be grouped (or clustered) according to more than one category (e.g., one or more values along N, M, and/or D dimensions described herein with respect to FIG. 3A) rather than on a single predetermined aspect (e.g., a value along one of the N, M, and/or D dimensions).

To support high frequency telemetry, the tree FM 200 may be trained and/or run in a distributed manner. For example, the leaf FMs may be trained locally at a device level, and other FM nodes (e.g., at the intermediate and final layers 206 and 208) may be located at the data center level.

The tree FM 200 may be trained as a unit without first pre-training the FM nodes 202, and/or the tree FM 200 may be trained after pre-training the FM nodes 202. The tree FM 200 may be trained as a unit using supervised learning and/or unsupervised learning. For example, if the final layer 208 of the tree FM 200 includes a task-dedicated head (e.g., a classifier) that uses a latent representation generated by the final layer 208 to generate the FM tree output 210, a set of training data including sets of input data (e.g., like the data stream(s) 101) and their corresponding ground truth data (e.g., classifications) may be used to train the tree FM 200 as a unit without first pre-training the FM nodes 202. Using such a training method, the tree FM may be trained to perform an objective at the lowest level of resolution (e.g., at a data center level or a floor level), instead of training each of the FM nodes 202 individually. By way of another non-limiting example, one or more layers of the tree FM 200 may include a task-dedicated head. In such embodiments, a latent representation generated by such layer(s) may be provided to an appropriate task-dedicated head, and a set of training data including sets of input data (e.g., corresponding to the input data provided to a portion of the tree FM 200 that terminates at the task-dedicated head) and their corresponding ground truth data may be used to train the portion of the tree FM 200 terminating at the task-dedicated head. Using such a training method, the tree FM 200 may be trained to perform an objective at one or more levels of resolution that are higher than the lowest level (e.g., a room level of the data center 100). Further, one or more of the FM nodes 202 of the tree FM 200 may be trained individually. With regard to unsupervised learning, any method of unsupervised learning may be used to train the tree FM 200, such as contrastive learning, autoregression learning, adversarial learning, generative learning, and/or one or more other unsupervised learning techniques.

FIG. 2B is a block diagram illustrating a plurality of tree FMs 220 arranged to produce output 230, in accordance with at least one embodiment. Each of the tree FMs 220 may be constructed as described herein. For example, the tree FM 200 (see FIG. 2A) may be used to implement one or more of the tree FMs 220. While FIG. 2B illustrates the tree FMs 220 arranged to define three layers 222, 224, and 226, the tree FMs 220 may be arranged to define any number of layers. For example, the second layer 224 may be omitted and the output of the first layer 222 may be supplied directly (as input) to the third (final) layer 226. By way of another non-limiting example, the second layer 224 may be characterized as being an intermediate layer and two or more intermediate layers may be positioned between the first layer 222 and the third layer 226. In such an arrangement, a first one of the intermediate layers receives the output of the first layer 222 as input and provides its output to another intermediate layer. Further, in such an arrangement, a last one of the intermediate layers receives the output of one of the intermediate layers as input and provides its output to the third layer 226. Any of the intermediate layers between the first and last intermediate layers receive the output of one of the intermediate layers as an input and provides its output to another of the intermediate layers. In embodiments that include only the first and last intermediate layers, the output of the first intermediate layer is provided as input to the last intermediate layer.

The base or first layer 222 has been illustrated as including tree FMs 222-1 to 222-E. The variable “E” may have any integer value greater than one. While illustrated as being different tree FMs, a single tree FM may be used to implement the tree FMs 222-1 to 222-E, for example, by processing different data (e.g., in series). Each of the tree FMs on the first layer 222 may have one or more leaf FMs that each receive a data stream (e.g., telemetry data, log data, etc.). The output of the tree FMs 222-1 to 222-E may be latent representations (e.g., sequences of vectors), or other values, such as those described herein.

While the second layer 224 has been illustrated as including tree FMs 224-1 to 224-F, the second layer 224 may include any number of tree FMs including a single tree FM. While illustrated as being different tree FMs, a single tree FM may be used to implement the tree FMs 224-1 to 224-F, for example, by processing different data (e.g., in series). At least some of the tree FMs of the second layer 224 may receive the output of the first layer 222 as input. For example, in FIG. 2B, the tree FM 224-1 is illustrated receiving the output of the tree FMs 222-1 and 222-2. The output of the tree FMs 222-1 and 222-2 may be latent representations (e.g., sequences of vectors), or other values, such as those described herein.

While the third layer 226 has been illustrated as including only tree FM 226-1, the third layer 226 may include any number of tree FMs. At least some of the tree FMs on the third layer 226 may receive the output of the second layer 224 as input. For example, in FIG. 2B, the tree FM 226-1 is illustrated receiving the output of the tree FMs 224-1 and 224-F. The output of the tree FM 226-1 may be a latent representation (e.g., a sequence of vectors), or other values, such as those described herein.

A structure defined by the tree FMs, such as a hierarchy, graph, etc., may be used to create output having different resolutions. For example, the first layer 222 may output a first resolution (e.g., a latent representation per device, such as a DGX), the second layer 224 may output a second resolution that is lower than the first resolution (e.g., a latent representation per group of devices, such as devices within a particular physical location), and the third layer 226 may output a third resolution that is lower than the second resolution (e.g., a latent representation per collection of groups of devices, such as groups of devices within a particular physical location).

The leaf FM(s) of each of the tree FMs on the first layer 222 may receive a data stream, for example, from a different device. For example, each of the tree FMs on the first layer 222 may have a leaf FM that receives a telemetry data stream related to a different GPU in a particular DGX. In this example, the output of the tree FMs on the first layer 222 may be a latent representation of the telemetry data associated with the GPUs of a different DGX. In other words, each of the tree FMs on the first layer 222 may output a latent representation corresponding to a different DGX (e.g., encoding telemetry data related to the GPUs of the DGX). Each tree FM on the second layer 224 may receive the output of any of the tree FMs on the first layer 222 that correspond to a DGX that is physically located in a particular room. In such an example, each of the tree FMs on the second layer 224 may output a latent representation corresponding to a different room in the data center 100. Continuing this example, each tree FM on the third layer 226 may receive the output of any of the tree FMs on the second layer 226 that correspond to a room that is physically located on a particular floor. In such an example, each of the tree FMs on the third layer 226 may output a latent representation corresponding to a different floor in the data center 100. By way of another non-limiting example, the tree FM 226-1 of the third layer 226 may receive the receive the output of all of the tree FMs on the second layer 226, and may output a latent representation corresponding to the data center 100. The output 230 of the third layer 226 may include the latent representation and/or one or more other values, such as those described herein, generated based at least in part on the latent representation produced by the tree FM 226-1. Thus, the tree FMs 220 may be used to produce output at different resolutions, e.g., at a device (e.g., DGX) level, a room level, a floor level, and/or a data center level. Further, the outputs of the tree FMs 220 may be combined in different manners to produce output(s) at different resolutions. By way of another non-limiting example, the tree FMs 220 may used to construct one or more different structures (e.g., one or more hierarchies, one or more graphs, etc.,) that may produce different output(s) and/or output(s) at different resolutions.

FIG. 3A illustrates a block diagram illustrating an example data structure 300, in accordance with at least one embodiment. The data structure 300 (e.g., a tensor) may be used by one or more processors (e.g., at least one or the processor(s) 105) and/or stored in memory (e.g., the storage 110 and/or the memory 112). The data structure 300 (e.g., a tensor) stores input data 302, such as samples collected from a particular device (e.g., from one of the server(s) 104). The input data 302 may be obtained from the data stream(s) 101 of FIG. 1.

Returning to FIG. 3A, the data structure 300 illustrated includes three dimensions, a dimension D represents intra-components, referred to as “instances” (e.g., GPUs within a deep learning system), a dimension M represents different variables, and a dimension N represents time steps. The data structure 300 may be transformed to enable a forward pass along the D (instance) dimension, M (variable) dimension, or N (time) dimension by at least one of the GPU(s) 108 (e.g., by one or more tensor cores of the GPU(s) 108). For example, a forward pass along the N dimension (referred to as a time pass) may include D×M sequences of length N. A forward pass along the M dimension (referred to as a variable pass) may include D×N sequences of length M. A forward pass along the D dimension (referred to as an instance pass) may include M×N sequences of length D.

FIG. 3B illustrates a block diagram illustrating an inference process 310 performed by a leaf FM of the tree FM 200, in accordance with at least one embodiment. The inference process 310 may be performed by the data center 100, a computing device, and/or one or more other computing systems. The FM functionality 116 (e.g., if performed by the processor(s) 105) may perform the inference process 310. For example, the FM functionality 116 may implement the leaf FM, which may perform at least a portion of the inference process 310.

The inference process 310 begins with the FM functionality 116 providing raw data 312 to a tokenization process 314 (e.g., implemented by the FM functionality 116). The raw data 312 may include multivariate data, multisource data, multimodal data, and/or multicomponent data. For ease of illustration, the raw data 312 will be described as being transmitted as a data stream. However, the raw data 312 may have any form, including being stored and read from files. The raw data 312 may be provided to the tokenization process 314 stored in the data structure 300 or the tokenization process 314 may store the data in the data structure 300. The tokenization process 314 may divide the input data 302 stored by the data structure 300 into segments (e.g., patches) and flatten the segments into one dimensional vectors (e.g., tokens). For example, the tokenization process 314 may divide each of the D×M sequences (e.g., matrices) into patches when performing a time pass. If the data structure 300 stores raw time series data, the tokenization process 314 may split a portion of the input data 302 (e.g., each of a set of matrices) into windows (or patches) that may or may not be overlapping (e.g., in a manner used by PatchTST). If the data structure 300 stores log messages, the tokenization process 314 may split a portion of the input data 302 (e.g., each of a set of matrices) into log messages with each log message being a segment or token (e.g., a vector). The tokens (e.g., vectors) may be arranged in a series, referred to an input sequence 316 of vectors.

In at least one embodiment, the FM functionality 116 supplies the input sequence 316 of vectors to a latent sequence generation process 322. The latent sequence generation process 322 encodes the input sequence 316 to obtain a latent sequence 324. The latent sequence generation process 322 may include normalizing the input sequence 316, and using a learned linear layer to project the normalized sequence to obtain the latent sequence 324. If the input sequence 316 encodes a time series, the latent sequence generation process 322 normalizes the input sequence 316 (e.g., using one or more RevIn operations), and uses a learned linear layer to project the input sequence 316. If the input sequence 316 encodes logs (e.g., syslogs), the latent sequence generation process 322 may use a learned layer or a pre-trained encoder (e.g., SBERT from the SentenceTransformer library) to encode the input sequence 316 and/or one or more templates.

In at least one embodiment, the FM functionality 116 supplies the latent sequence 324 of vectors to neural network 326, which output a latent representation 328. The neural network 326 may be implemented using a transformer encoder, a language model (e.g., a large language model (LLM), a small language model (SLM), a vision language models (VLM), a multi-modal language model (MMLM), etc.), a vision-language-action (VLA) model, a recurrent neural network (RNN), a long short-term memory network (LSTM), a gated recurrent unit (GRU), a convolutional neural network (CNN) for sequences, a memory-augmented neural network, an attention mechanism without a transformer, a graph neural network (GNN), an echo state network (ESN), reservoir computing, a self-attention mechanism, a bidirectional RNN, a bidirectional LSTM, a bidirectional GRU, a temporal convolutional network (TCN), a WaveNet, a capsule network, and/or another type of machine learning process. The FM functionality 116 may supply the latent representation 328 (e.g., a sequence of vectors) to one or more other FM nodes 202 of the tree FM 200, to one or more FM nodes of another tree FM (e.g., like the tree FM 200), and/or to one or more other processes (e.g., a machine learning process, an AI, one or more task-dedicated heads, and/or the like).

FIG. 3C illustrates a block diagram illustrating an inference process 330 performed by a FM node of the tree FM 200 (see FIG. 2A) that may be other than a leaf FM, in accordance with at least one embodiment. The inference process 330 may be performed by the data center 100, a computing device, and/or one or more other computing systems. The FM functionality 116 (e.g., if performed by the processor(s) 105) may perform the inference process 310. For example, the FM functionality 116 may implement the FM node, which may perform at least a portion of the inference process 330. The FM node may be on an intermediate layer (e.g., the intermediate layer 206) or the final layer 208. In at least one embodiment, the FM node may be on the first layer 204 but may receive one or more latent representations (e.g., from a different tree FM) instead of other types of data, such as a data stream or data file.

The inference process 330 begins with the FM functionality 116 receiving one or more latent representations 332 (e.g., each like the latent representation 328). Each of the latent representation(s) 332 may be stored in the data structure 300 or the GPU(s) 108 (e.g., performing the FM functionality 116) may store the latent representation(s) 332 in the data structure 300.

In at least one embodiment, the FM functionality 116 supplies the latent representation(s) 332 to a latent sequence generation process 338 (e.g., like the latent sequence generation process 322), which outputs a latent sequence 350 of vectors. The latent sequence generation process 338 may include an alignment process 340, which outputs an aligned sequence 342 of vectors for each of the latent representation(s) 332. The alignment process 340 may bridge a gap between data generated at different frequencies (high and low), by aligning the latent representation(s) 332 by timestamp, and interpolating (e.g., when aligning low frequency data with high frequency data) or pooling (e.g., when aligning high frequency data with low frequency data). By way of a non-limiting example, data collected by a DCGM may include multivariate time series data, such as a collection of counter measurements over time for a number of hosts (e.g., DGXs), and Kernel Syslogs may include semi-structured data (logs) collected from one or more kernel applications performed by the hosts (e.g., the DGXs). For the DCGM data and the Kernel Syslogs, an aligned sample may be defined by DGX id and time period <tᵢ, tᵢ₊₁>. For example, if the time period is 15 minutes, tᵢ₊₁−tᵢ=15 minutes. The DCGM data and the Kernel Syslogs are aligned if they related to the same time period and the same DGX identified by the DGX id. Using the time period (defined by tᵢ and tᵢ₊₁) and the DGX id, the alignment process 340 may align the DCGM data and the Kernel Syslogs by fetching logs from a syslog table (indexed by host identifier, DGX id) and DCGM data both corresponding to the time period and the DGX id.

By way of a non-limiting example, a first device (e.g., a GPU) sends first telemetry data at a first frequency (e.g., every 30 s), and a second device (e.g., a network NIC) sends second telemetry data at a different second frequency (e.g., 5 min). The first and second telemetry data from both the first and second devices includes multivariate time-series data. The alignment process 340 may align the first and second telemetry data of the first and second devices by using the higher first frequency as a sampling rate, and adding another feature vector that measures availability of a sample in the second telemetry data at each specific time point (e.g., timestamp) in the first telemetry data. For example, that other feature vector may store an offset between each time point of the first telemetry data (e.g., a timestamp corresponding to when each data point in the first telemetry data was received) and an exact time-point (e.g., timestamp) at which each data point of the second telemetry data was received. The offset vector may store values normalized to be within a range [−0.5, 0.5]. Within this range, a value of zero may indicate that a data point of the first telemetry data and a data point of the second telemetry data are associated with the same time point (e.g., timestamp), meaning the data points were received at the same time or are coincident. Within the range, a value of −0.5 indicates that a data point of the second telemetry data arrived halfway in between a particular time point (e.g., timestamp) associated with a particular data point within the first telemetry data and a previous time point (e.g., timestamp) associated with a previous data point of the first telemetry data. Similarly, within the range, a value of 0.5 indicates that a data point of the second telemetry data arrived halfway in between a particular time point (e.g., timestamp) associated with a particular data point within the first telemetry data and a next time point (e.g., timestamp) associated with a next data point of the first telemetry data.

The latent sequence generation process 338 may supply the aligned sequence(s) 342 of vectors to a fusion process 344, which outputs a fused sequence 346 of vectors. The fusion process 344 may combine (e.g., concatenating) the aligned sequence(s) 342 of vectors, which were obtained from other FMs from the same or a different tree FM. The fusion process 344 may combine and/or fuse the aligned sequence(s) 342 by, for example summing the aligned sequence(s) 342, concatenating the aligned sequence(s) 342, and/or providing the aligned sequence(s) 342 as input to a trained linear layer to generate the fused sequence 346 of vectors.

The latent sequence generation process 338 may supply the fused sequence 346 of vectors to a linear layer 348 that outputs the latent sequence 350 of vectors. In some embodiments, the linear layer 348 may be omitted and the latent sequence generation process 338 may output the fused sequence 346 as the latent sequence 350.

In at least one embodiment, the FM functionality 116 supplies the latent sequence 350 of vectors to a neural network 352 (e.g., like the neural network 326), which outputs a latent representation 354. In some embodiments, the neural network 352 may be implemented as at least one transformer encoder, at least one hybrid encoder, at least one decoder, at least one State Space Model (SSM), and/or another type of model may be used. The FM functionality 116 may supply the latent representation 354 (e.g., a sequence of vectors) to one or more other FM nodes 202 of the tree FM 200, to one or more FM nodes of another tree FM (e.g., like the tree FM 200), and/or to one or more other processes (e.g., a machine learning process, an AI, one or more task-dedicated heads, and/or the like).

The tree FM 200 may be trained to perform inference using the data stream(s) 101 (e.g., collected by the data center 100) that may include high frequency telemetry data. Using the FM nodes 202 to construct the tree FM 200 may be characterized as providing an explainability framework for foundational models for a data center (e.g., the data center 100). The tree FM 200 may be evaluated using an evaluation framework, such as one or more evaluation framework described herein for evaluating foundational models for data centers. The FM nodes 202 may be organized within a hierarchical FM (e.g., the tree FM 200) to represent topology of the data center 100.

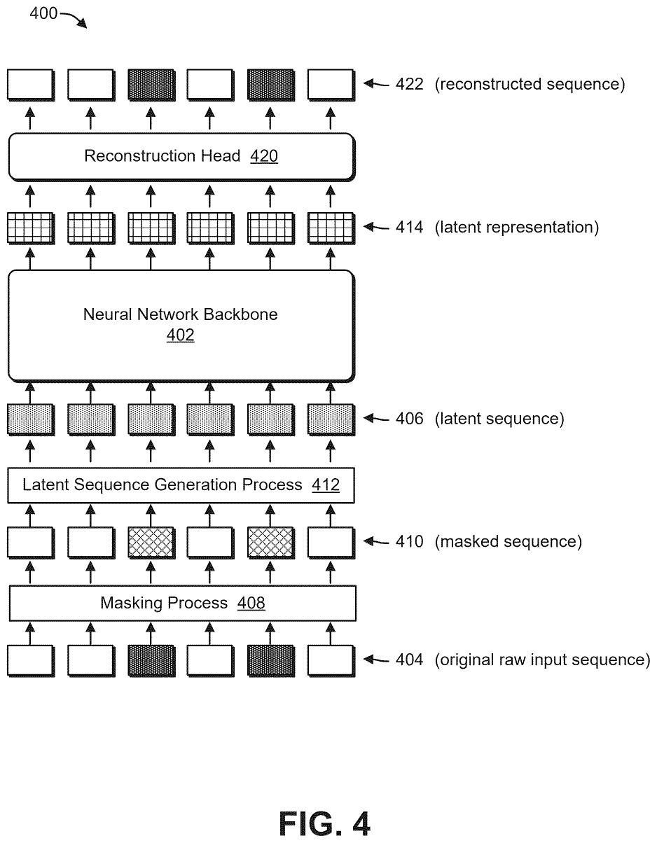

FIG. 4 illustrates a block diagram depicting a training process 400, in accordance with at least one embodiment. One or more computing systems (e.g., one or more of the server(s) 104, or another computing system) may use the training process 400 to train one or more of the FM nodes 202 (see FIG. 2A) of the tree FM 200 (see FIG. 2A). For example, the FM functionality 116 when performed by one or more of the processor(s) 105 may perform the training process 400. For example, the training process 400 may be used to train leaf FMs or other FM nodes.

Referring to FIG. 3B, each of the FM nodes 202 of the tree FM 200 may include a neural network backbone 402 (e.g., the neural network 326 or the neural network 352), which may be implemented as a transformer encoder with K layers. A transformer encoder with K layers may include K identical layers that each perform a series of operations to transform the input data into a more abstract representation, capturing complex patterns and/or dependencies. Each of the K layers may include a multi-head self-attention process that simultaneously adjusts weights or attention scores associated with different parts of (e.g., patches or segments obtained from) the input sequence (referred to as tokens) to draw attention to some parts over others. The multi-head self-attention process may compute attention scores for each token relative to every other token, which enabled the transformer encoder to capture relationships and/or dependencies between the tokens. Each of the K layers may include a feed-forward neural network, which may receive output from the self-attention mechanism, a perform a first linear transformation on the output, perform a non-linear activation function on the output of the first linear transformation, and perform a second linear transformation on the output of the non-linear activation function. Next, each of the K layers may perform layer normalization to normalize the output of the feed-forward neural network. Each of the K layers may include one or more residual connections that bypass the multi-head self-attention process and/or the feed-forward neural network of the layer to allow the transformer encoder to retain information from earlier layers, and/or improve gradient flow during training.

In the embodiment illustrated in FIG. 4, one or more of the FM nodes 202 of the tree FM 200 is/are trained to perform a masked token prediction, which may be considered an objective of this training. However, this is not a requirement and in other embodiments, the FM may be trained to achieve other objectives. For example, the FM node(s) may be trained to predict a next token. In at least one embodiment, instead of or in addition to a transformer encoder, the neural network backbone 402 of one or more of the FM nodes 202 of the tree FM 200 may include one or more decoders that perform next token prediction. In some embodiments, instead of or in addition to a transformer encoder, the neural network backbone 402 of one or more of the FM nodes 202 of the tree FM 200 may include one or more diffusion models to achieve one or more different objectives.

When the training process 400 is performed by one or more of the processor(s) 105, input data (e.g., the input data 302 illustrated in FIG. 3A) may be encoded into a latent sequence 406 of vectors. For example, referring to FIG. 3A, the data structure 300 may store the input data (e.g., obtained from one or more of the data stream(s) 101 illustrated in FIG. 1) that the GPU(s) 108 (see FIG. 1) may divide into segments (e.g., patches) and flatten those segments into an input sequence 404 of vectors (e.g., the input sequence 316 or the latent representation(s) 332). In this manner, before the input data is encoded, the input data may be split into two or more segments, which may be flattened to produce two or more tokens that may be arranged to define the input sequence 404 of vectors. As a non-limiting example, if the input data comprises logs, each log message may be a segment or a token (e.g., a vector), and the tokens may be arranged to define the input sequence 404 of vectors. For ease of illustration, only the single input sequence 404 of vectors has been illustrated but the GPU(s) 108 may generate two or more input sequences of vectors.

Then, the FM functionality 116 may perform a masking process 408 that masks the input sequence 404 of vectors (e.g., using one or more masks) to produce a masked sequences 410 of vectors. For example, one or more randomly selected tokens (e.g., vectors of the input sequence 404) may be masked to form the masked sequence 410. For ease of illustration, only the single masked sequence 410 has been illustrated but the masking process may be used to generate two or more masked sequences. The FM functionality 116 may obtain the latent sequence 406 by performing a latent sequence generation process 412 (e.g., the latent sequence generation process 322 or the latent sequence generation process 338) using the masked sequence 410. The latent sequence generation process 412 may include normalizing the masked sequence 410, and using a learned linear layer to project the normalized sequence.

In at least one embodiment, the masking process 408 may be omitted. In such embodiments, the FM functionality 116 may obtain the latent sequence 406 by performing the latent sequence generation process 412 (e.g., the latent sequence generation process 322 or the latent sequence generation process 338) using the input sequence 404 of vectors instead of the masked sequence 410. The latent sequence generation process 412 may normalize the input sequence 404, and use a learned linear layer to project the normalized sequence. In embodiments in which the input sequence 404 includes one or more latent representations output by FM nodes of the tree FM 200 or another tree FM, the latent sequence generation process 412 may perform an alignment process (e.g., like the alignment process 340), a fusion process (e.g., like the fusion process 344), and/or a linear layer (e.g., like the linear layer 348).

The latent sequence 406 of vectors is input into the neural network backbone 402, which may be, as an example, a transformer encoder with K layers. Each layer may operate on or at each dimension encoded by the latent sequence 406, such as the N (time) dimension, the M (variable) dimension for multivariate time series, and/or the D (instance) dimension when the data is related to multiple sources (e.g., networking or compute).

The neural network backbone 402 may learn patterns from the latent sequence 406 and output a latent representation 414 (e.g., a sequence of vectors). The neural network backbone 402 may be trained using self supervision, such as reconstruction, contrastive learning, autoregression, and/or one or more other learning objectives. For example, during training, each of the FM nodes 202 may include a reconstruction head 420 that uses the latent representation 414 to predict a reconstructed sequence 422 of vectors. The prediction may be compared to a ground truth sequence, and the results of this comparison are used to update the neural network backbone 402 of the FM node (e.g., to update parameters, such as weights, used by the neural network backbone 402). The ground truth sequence is the sequence, for example, the masked sequence 410 or the original input sequence 404, that was input in the latent sequence generation process 412 to obtain the latent sequence 406.

The reconstruction head 420 may include one or more layers that transform the latent representation 414 into the reconstructed sequence 422 of vectors. These layer(s) may include one or more dense layers (e.g., one or more Fully Connected layers) that map the latent representation 414 to a higher-dimensional space that matches the dimensionality of a ground truth sequence (e.g., the masked sequence 410 or the original input sequence 404). The dense layer(s) may apply linear transformations followed by non-linear activation functions. Non-limiting examples of activation functions, include Rectified Linear Unit (ReLU), sigmoid, and/or tanh. The layer(s) of the reconstruction head 420 may include one or more recurrent layers that may be used to capture temporal dependencies and/or to reconstruct a sequence over time. Non-limiting examples of the recurrent layer(s) include Long Short-Term Memory (LSTM) or Gated Recurrent Unit (GRU). The layer(s) of the reconstruction head 420 may include one or more convolutional layers, which for example may be used for image data and/or time series data. The convolutional layer(s) may be used to reconstruct spatial features and/or to upsample the latent representation 414 to match the dimensions of the ground truth sequence (e.g., the masked sequence 410 or the original input sequence 404). The convolutional layer(s) (e.g., one dimensional convolutional layer(s)) may be used to capture local patterns in the time series data, and/or to help reconstruct features spread over time. The layer(s) of the reconstruction head 420 may include one or more upsampling layers, if the latent representation 414 is smaller than the ground truth sequence (which is common in image processing). Non-limiting examples of upsampling layers include transposed convolutions or nearest-neighbor upsampling, which may be used to increase the spatial dimensions. The upsampling layer(s) may perform interpolation and/or transposed convolutions. The layer(s) of the reconstruction head 420 may include one or more output layers that match dimensionality of the input data. For continuous data, the output layer(s) may include a linear layer, while for categorical data, the output layer(s) may include a softmax. The layer(s) of the reconstruction head 420 may include one or more normalization layers, such as batch normalization or layer normalization that help stabilize training and/or improve convergence.

A loss function, such as mean squared error (MSE) for continuous data or cross-entropy loss for categorical data, may be used to evaluate the quality of the reconstruction. For example, MSE may be used with time series data (e.g., to reconstruct the time series data). By way of another non-limiting example, cross-entropy loss may be used to classify tokens within a vocabulary (e.g., to classify a token representing a word, a phrase, or part of a word). The neural network backbone 402 may be trained to minimize a loss value calculated using the loss function. The FM nodes may be characterized as being trained using self-supervised learning because labeled data is not required to train the FM nodes.

In at least one embodiment, instead of or in addition to training a FM node to predict the ground truth sequence (e.g., the masked sequence 410 or the original input sequence 404), the FM node may be trained using contrastive, adversarial, and/or generative objectives. For example, augmentations of the raw input data (e.g., the input sequence 404) input into the leaf FMs can be used to generate positive examples of latent representations and/or negative examples of latent representations for contrastive objectives, which may include bringing the latent representations produced by the FM node closer to the positive examples and further apart from the negative examples.

When the FM nodes 202 perform one or more downstream tasks, e.g., a classification, regression, anomaly detection, etc., the reconstruction head 420 of each of the FM nodes 202 may be omitted or replaced with one or more task-dedicated heads (e.g., a head trained to perform classification, regression, anomaly detection, etc.) that fine-tune(s) the FM node to perform the downstream task(s). For example, the final layer 208 may pool the latent representation 414 output by more than one FM node, and the FM functionality 116 may train a dedicated classification head in a supervised manner. By way of another non-limiting example, the latent representations learned can be pooled (e.g. using a mean or a last element) for zero-shot and few-show tasks.

The output of any of the FM nodes 202 omitting the reconstruction head 420 may be the latent representation 414. In such embodiments, the latent representations produced by the FM nodes of a layer are provided as input to child FM nodes of an adjacent layer. The output of any of the FM nodes 202 in which the reconstruction head 420 is replaced with task-dedicated head(s) may be the output of the task-dedicated head(s). For example, the reconstruction head 420 of FM nodes on the first and intermediate layers 204 and 206 may be omitted, and the reconstruction head 420 of FM nodes on the final layer 208 may be replaced with task-dedicated head(s). In such embodiments, the FM tree output 210 of the tree FM 200 may include the output of the task-dedicated head(s), such as one or more classifications (e.g., a per token classification, a per latent representation classification, and/or others), one or more regression, identification of one or more anomalies in the latent representation 414 output by the FM nodes on the final layer 208, etc.

The attention mechanism of the neural network backbone 402 improves interpretability of the data stream(s) 101, by providing a way to visualize relative importance of inputs at different levels. The tree FM 200 may be used to perform simulations, by augmenting the inputs (e.g., the data stream(s) 101), and observing responses in the predicted forecasted values (e.g., the latent representation 414, the reconstructed sequence 422, and/or one or more values output by one or more task-dedicated heads).

After the FM nodes 202 are trained (e.g., using the training process 400), they may be assembled into the tree FM 200 and/or another FM with a hierarchical structure, and used to perform one or more tasks. The task(s) may include producing, as the FM tree output 210, a latent representation (e.g., a sequence of vectors) for data collected with respect to one or more devices in the data center 100. The latent representation may be produced by omitting the reconstruction head 420 from the FM nodes 202, and using the FM nodes to construct the tree FM 200. Then, the FM functionality 116 may input the data stream(s) 101 into the tree FM 200, which uses the data stream(s) to produce the FM tree output 210, which may be a latent representation. The data stream(s) 101 may include diverse streams of time series and semi-structured data (logs) at high frequency. Such streams may transmit and include large amounts of data. The data stream(s) 101 may be output from one or more devices (e.g., included in the data center 100 and/or external to the data center 100) or otherwise collected with respect to the device(s).

The FM nodes 202 may enable data-driven decision making by providing the FM tree output 210 (e.g., the latent representation) to one or more machine learning processes, such as one or more task-dedicated heads (e.g., a head trained to perform classification, regression, anomaly detection, etc.). The data included in the data stream(s) 101 that is used to produce the FM tree output 210 may include multivariate data from multiple sources, data having different modalities, data from one or more devices, and/or data that differs in other ways. The FM functionality 116 may transfer the FM tree output 210 (e.g., a latent representation) to one or more downstream processes (e.g., one or more machine learning processes, such as one or more neural networks), and perform one or more downstream tasks (e.g. forecasting and anomaly detection) using the FM tree output 210. The FM functionality 116 may fine-tune the trained FM nodes 202 (e.g., using linear probing, zero-shot performance, zero-shot performance through retrieval, and/or other techniques). One or more task-dedicated heads may be used with one or more of the FM nodes 202 to allow the FM node(s) to be used with new and/or changing technologies. The FM functionality 116 may train the FM nodes 202 with or without one or more task-dedicated heads using sparse and/or noisy supervision signals. The FM functionality 116 may train the tree FM 200 in a hierarchical manner, and/or the tree FM 200 may learn in a hierarchical manner from one or more of the data stream(s) 101 generated and/or received by the data center 100. For example, the FM functionality 116 may use output of the FM nodes on the first layer 204 to train and/or fine-tune the FM nodes on the intermediate layer 206, and the FM functionality 116 may use output of the FM nodes on the intermediate layer 206 to train and/or fine-tune the FM node(s) on the final layer 208.

For example, DCGM data may include time series multivariate data collected from multiple devices of a deep learning system (e.g., DGX). By way of a non-limiting example, each of these devices may include a number of GPUs (e.g., eight GPUs). The FM functionality 116 may receive the DCGM data as one or more of the data stream(s) 101 collected from each of the GPUs. The modality of the data streams transmitting such DCGM data is time series, and each of at least a portion of the data streams may be associated with a value of a variable “source.” Examples of such values include “compute” and “networking,” which may mean that the data stream includes data related to compute or networking. By way of a non-limiting example, the value of the variable “source” may be stored in the M (variable) dimension. In its forward pass, the FM nodes 202 may attend to the N (time), M (variable), and D (instance) (e.g., GPUs) dimensions in an interleaved or sequential manner by reshaping or transforming the data structure 300 (e.g., a tensor) as described herein. Each of the FM nodes on the first layer 204 (referred to as leaf FM) may receive a data stream transmitting DCGM data collected from one of the GPUs of one of the devices of the deep learning system.

The latent representation 414 learned by each of the leaf FM may be aligned (e.g., by the alignment process 340) by time and aggregated (across values of the variable “source”) by the devices of the deep learning system. In other words, each of the FM nodes of the intermediate layer 206 may receive the latent representation 414 output by those of the leaf FM that received data streams output by the GPUs of the same device of the deep learning system, and aggregates the data in such data streams for the device. For example, if the deep learning system includes two devices each having eight GPUs, a first FM node of the intermediate layer 206 will aggregate the latent representation 414 received from those leaf FM that processed data streams from the eight GPUs of a first one of the devices, and a second FM node of the intermediate layer 206 will aggregate the latent representation 414 received from those leaf FM that processed data streams from the eight GPUs of a second one of the devices. Such FM nodes of the intermediate layer 206 may learn a certain aspect of the data center 100, such as compute versus networking. Finally, the FM nodes at the upper levels of the tree FM (e.g., at the final level 208) may leverage representations of neighboring ones of the devices of the deep learning system (e.g., two or more devices that are connected in the physical data center 100).

Referring FIG. 2A, a hierarchical FM, like the tree FM 200, may be used to perform classification of failure at FM node level. For example, lower layers (e.g., the first layer 204) may receive DCGM data and Syslogs collected with respect to compute operations performed by hosts (e.g., deep learning systems) as well as other system data (e.g., CollectX data) and system management logs (e.g., SMlogs) from one or more systems, for example, in a Hybrid Cube Architecture (HCA). A next layer (e.g., the intermediate layer 206) may align and fuse output from two or more of FM nodes on the lower layers. A final layer (e.g., the final layer 208) may align and fuse output from two or more of FM nodes on the second layer. The FM functionality 116 may finetune a classification linear layer on the final layer (e.g., the final layer 208) using output from the second layer to classify failure. In at least one embodiment, the classification linear layer may aggregate the outputs of the FM nodes of the second layer. In at least one embodiment, the final layer may include one or more FM nodes, and a task-dedicated head may be used to implement the classification linear layer. The classification linear layer may receive and classify the latent representation output by the FM node(s) of the final layer. The hierarchical FM (e.g., the tree FM 200) may be used to perform forecasting and/or anomaly detection. In this example, the classification linear layer may be replaced with a task-dedicated head that receives and processes latent representation output by the FM node(s) of the final layer to generate a forecast and/or perform anomaly detection. In addition, zero-shot performance may be used. For example, for anomaly detection, the hierarchical FM may detect an anomaly if the reconstruction of the inputs (e.g., the reconstructed sequence 422 illustrated in FIG. 4) deviates from the actual observed values (e.g., the masked sequence 410 or the input sequence 404), which indicates a deviation from expected and/or normal behavior.

A hierarchical FM, like the tree FM 200, may be used to perform general monitoring of cluster health. In such embodiments, a final layer (e.g., the final layer 208) may include one or more FM nodes that output latent representation(s) to a task-dedicated head, such as a classification head, that is finetuned to perform this task.

A hierarchical FM, like the tree FM 200, may be used to fuse intra-device data streams and/or inter-device data streams. For example, the FM functionality 116 may use the hierarchical FM to fuse inter-device data streams collected with respect to multiple devices to perform troubleshooting and/or failure prediction in cases in which multiple devices participate in a failure. An example of such a failure is switch failure. The hierarchical FM may receive data streams transmitting telemetry data related to nodes connected to a switch, fuses data from the switch and/or the nodes connected to the switch, and classifies the failure as related to the switch (e.g., using the classification linear layer described herein). The hierarchical FM (e.g., the tree FM 200) may be used to fuse intra-device data streams when multiple modality data is available for the same device (e.g. telemetry data and/or logs). For example, the device may fuse the intra-device data streams to generate a latent representation that may be used (e.g., by another hierarchical FM) to perform inter-device fusion.

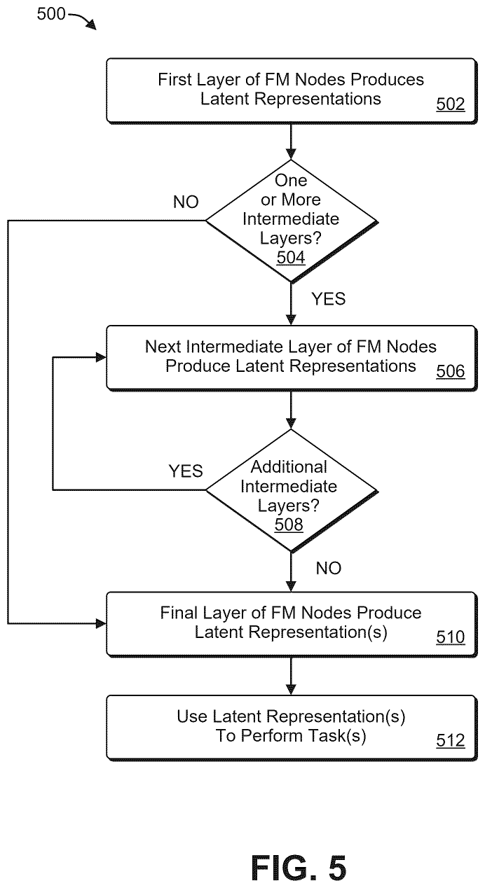

FIG. 5 is a flow diagram illustrating a method 500 of using a hierarchical FM (e.g., the tree FM 200 illustrated in FIG. 2A), in accordance with at least one embodiment. The method 500 may be performed by the data center 100, a computing device, and/or one or more other computing systems. The FM functionality 116 (e.g., if performed by the processor(s) 105) may perform the method 500. For example, the FM functionality 116 may implement the tree FM 200, which may perform at least a portion of the method 500. Before the method 500 is performed, data (e.g., the data stream(s) 101) is collected and provided to the hierarchical FM. The data may include multivariate data, multisource data, multimodal data, and/or multicomponent data. For ease of illustration, the data will be described as being transmitted as data streams. However, the data may have any form, including being stored and read from files.

At block 502, one or more leaf FMs of the first layer (e.g., the first layer 204) of the hierarchical FM (e.g., the tree FM 200) process the data stream(s) and each produces a latent representation (e.g., the latent representation 414). For example, each of the leaf FM(s) may process a different data stream, and output a different latent representation corresponding to the data stream. To process a data stream, one of the leaf FM(s) may store a portion of the data stream in a data structure (e.g., the data structure 300). One or more GPU(s) (e.g., the GPU(s) 108 illustrated in FIG. 1) may divide the data stored in the data structure into segments (e.g., patches), and flatten those segments into an input sequence of vectors (e.g., the input sequence 404). As another non-limiting example, if the input data comprises logs, each log message may be a segment or a token (e.g., a vector), and the tokens may be arranged to define the input sequence of vectors (e.g., the input sequence 404). Then, the GPU(s) of the leaf FM may perform the masking process 408 to obtain a masked sequence of vectors (e.g., the masked sequence 410). Next, the GPU(s) of the leaf FM may perform the latent sequence generation process 412 to obtain a latent sequence of vectors (e.g., the latent sequence 406). The GPU(s) of the leaf FM implement a neural network backbone (e.g., the neural network backbone 402). The GPU(s) of the leaf FM provide the latent sequence of vectors (e.g., the latent sequence 406) to the neural network backbone as input, and the neural network backbone outputs a latent representation (e.g., the latent representation 414). For example, at block 506, each of the leaf FM(s) of the first layer may perform the inference process 310.

At decision block 504, if the hierarchical FM (e.g., the tree FM 200) includes one or more intermediate layers (e.g., the intermediate layer 206), the decision at decision block 504 is “YES.” Otherwise, the decision at decision block 504 is “NO.” When the decision at decision block 504 is “YES,” the FM functionality 116 provides the latent representations output by the leaf FMs in block 502 to a first intermediate layer of the intermediate layer(s) as input, and advances to block 506. Otherwise, if the decision at decision block 504 is “NO,” the FM functionality 116 provides the latent representations output by the FM node(s) in block 502 to a final layer (e.g., the final layer 208), and advances to block 510.

At block 506, the FM functionality 116 uses one or more FM nodes of a particular one of the intermediate layer(s) (e.g., the intermediate layer 206) of the hierarchical FM (e.g., the tree FM 200) to process the latent representation(s) input into the FM nodes of the particular intermediate layer. Each of the FM nodes of the particular intermediate layer may receive two or more latent representations from two or more different adjacent (e.g., lower) FM nodes as input, align these input latent representations, fuse or otherwise combine these aligned latent representations, and output an intermediate latent representation. For example, at block 506, each of the FM node(s) of the particular intermediate layer may perform the inference process 330.

At decision block 508, if the hierarchical FM (e.g., the tree FM 200) includes one or more additional (e.g., upper) intermediate layers, the decision at decision block 508 is “YES.” Otherwise, the decision at decision block 508 is “NO.” When the decision at decision block 508 is “YES,” the FM functionality 116 provides the latent representation(s) output by the FM node(s) in block 506 to a next intermediate layer of the intermediate layer(s) as input, and returns to block 506. Otherwise, if the decision at decision block 508 is “NO,” the FM functionality 116 provides the latent representation(s) output by the FM node(s) in block 506 to the final layer (e.g., the final layer 208), and advances to block 510.

At block 510, the FM functionality 116 uses one or more FM nodes of a final layer (e.g., the final layer 208) of the hierarchical FM (e.g., the tree FM 200) to process the latent representation(s) input into the FM node(s) of the final layer. Each of the FM nodes of the final layer may receive two or more latent representation(s) from two or more different adjacent (e.g., lower) FM nodes as input, align these input latent representations, fuse or combine these aligned latent representations, and output one or more final latent representations. For example, at block 510, each of the FM node(s) of the final layer may perform the inference process 330.

At block 512 the FM functionality 116 and/or another process (e.g., machine learning process(es) and/or AI(s)) may use the final latent representation(s) generated by block 510 to perform one or more tasks. For example, the FM functionality 116 and/or another process may provide the final latent representation(s) generated by block 510 to one or more neural networks trained to perform inferencing using the final latent representation(s). Such neural network(s) may analyze the final latent representation(s), which encode multivariate data, to identity patterns, correlations, trends, and/or other information present in at least a portion of the data streams. By way of additional non-limiting examples, the neural network(s) may use the final latent representation(s), which encode multimodal data, to infer information related to complex phenomena and/or a complex situation. The FM functionality 116 and/or another process may provide the final latent representation(s) to one or more machine learning processes, such as one or more neural networks, to perform classification, regression, anomaly detection, and/or one or more other tasks. The method 500 may terminate after block 512.

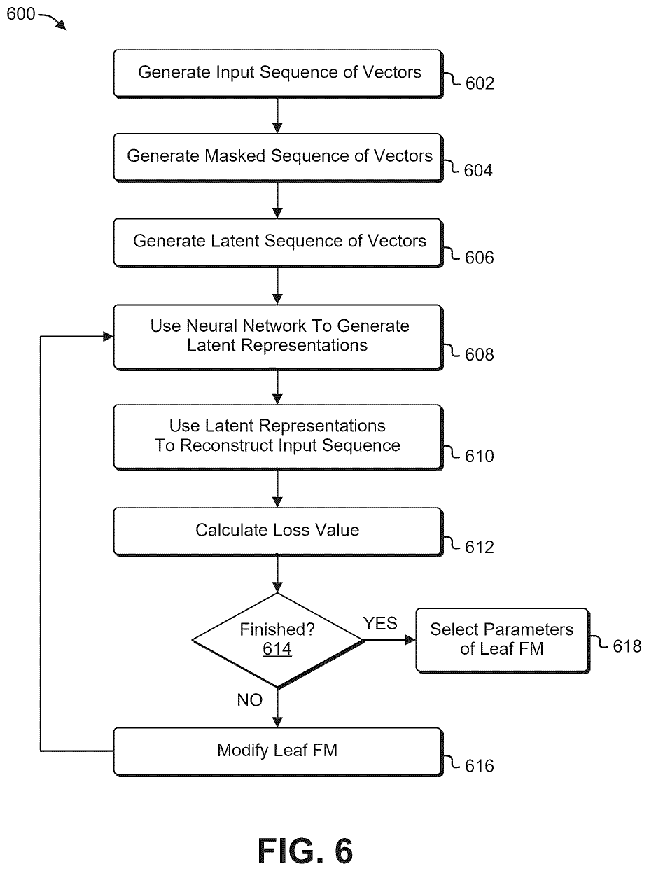

FIG. 6 is a flow diagram illustrating a training method 600 that may be used to train a leaf FM of a hierarchical FM (e.g., the tree FM 200 illustrated in FIG. 2A), in accordance with at least one embodiment. The training method 600 may be performed by the data center 100, a computing device, and/or one or more other computing systems. The FM functionality 116 (e.g., if performed by the processor(s) 105) may perform the training method 600. For example, the FM functionality 116 may implement one or more FM nodes, which may each be trained using the training method 600. Before the method 500 is performed, data (e.g., one of the data stream(s) 101) is collected and provided to the leaf FM. The data may include multivariate data, multisource data, multimodal data, and/or multicomponent data. For ease of illustration, the data will be described as being transmitted as a data stream. However, the data may have any form, including being stored and read from a file.

At block 602, the FM functionality 116 causes processor(s) (e.g., the GPU(s) 108) to generate an input sequence of vectors (e.g., the input sequence 404 of vectors) based at least in part on the input data stream. In at least one embodiment, the FM functionality 116 causes processor(s) (e.g., the GPU(s) 108) to perform the tokenization process 314 in block 602.

At block 604, the FM functionality 116 causes processor(s) (e.g., the GPU(s) 108) to perform the masking process 408 to produce the masked sequence of vectors (e.g., the masked sequence 410 of vectors) based at least in part on the input sequence of vectors obtained at block 602.

At block 606, the FM functionality 116 causes the processor(s) (e.g., the GPU(s) 108) to perform the latent sequence generation process 412 to produce the latent sequence of vectors (e.g., the latent sequence 406 of vectors) based at least in part on the masked sequence of vectors obtained at block 604. In at least one embodiment, block 604 is omitted. In such embodiments, the FM functionality 116 causes the processor(s) (e.g., the GPU(s) 108) to perform the latent sequence generation process 412 to produce the latent sequence of vectors (e.g., the latent sequence 406 of vectors) based at least in part on the input sequence of vectors generated in block 602.

At block 608, the FM functionality 116 causes the processor(s) (e.g., the GPU(s) 108) to provide the latent sequence of vectors obtained at block 606 to a neural network encoder (e.g., the neural network backbone 402), which generates a latent representation (e.g., a new latent sequence of vectors) based at least in part on the latent sequence of vectors obtained at block 606.

At block 610, the FM functionality 116 causes the processor(s) (e.g., the GPU(s) 108) to provide the latent representation (e.g., the latent representation 414) obtained at block 608 to the reconstruction head 420, the reconstruction head 420 predicts a reconstructed sequence of vectors (e.g., the reconstructed sequence 422).

At block 612, the FM functionality 116 calculates a loss value (using a loss function) based at least in part on results of a comparison of the reconstructed sequence of vectors to a ground truth sequence. The ground truth sequence is the sequence that was input into the latent sequence generation process 412 and used thereby to generate the latent sequence of vectors at block 606. In embodiments that include block 604, the ground truth sequence is the masked sequence output by block 604. Otherwise, the ground truth sequence is the input sequence of vectors (e.g., the input sequence 404) output by block 602.

At decision block 614, the FM functionality 116 determines whether sufficient training iterations have been performed. The decision at decision block 614 is “YES,” when the FM functionality 116 is finished performing training iterations. Otherwise, the decision at decision block 614 is “NO.” When the decision at decision block 614 is “NO,” at block 616, the FM functionality 116 modifies one or more parameters of the leaf FM (e.g., weights of the neural network (e.g., the neural network backbone 402), and returns to block 608 to perform another iteration. On the other hand, when the decision at decision block 614 is “YES,” at block 618, the FM functionality 116 selects the parameter(s) of the leaf FM (e.g., weights of the neural network (e.g., the neural network backbone 402) that output the latent representation that resulted in the smallest loss value. The FM functionality 116 may configure the neural network using the parameters selected at block 618. The training method 600 may terminate after block 618.

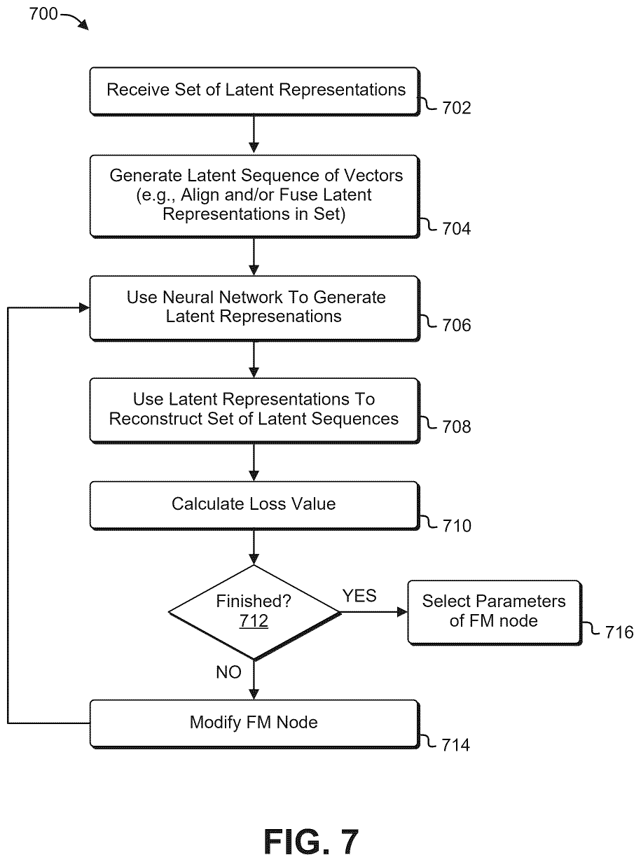

FIG. 7 is a flow diagram illustrating a training method 700 that may be used to train a FM node of a hierarchical FM (e.g., the tree FM 200 illustrated in FIG. 2A), in accordance with at least one embodiment. The training method 700 may be performed by the data center 100, a computing device, and/or one or more other computing systems. The FM functionality 116 (e.g., if performed by the processor(s) 105) may perform the training method 700. For example, the FM functionality 116 may implement one or more FM nodes, which may each be trained using the training method 700. Any of the FM nodes on any of the layers of the hierarchical FM (e.g., the tree FM 200) may be trained using the training method 700.

At block 702, the FM functionality 116 receives a set of latent representations and provides the set to the FM node. For example, the FM node may a child node and the FM functionality 116 may receive one or more of the latent representations from at least one parent node of the FM node. By way of another non-limiting example, the FM node may be a leaf FM, and the FM functionality 116 may receive two or more latent representations (e.g., the latent representations 332-1 to 332-P) from another hierarchical FM. The latent representations may encode data (e.g., at least one of the data stream(s) 101). The data may include multivariate data, multisource data, multimodal data, and/or multicomponent data. The latent representations may have any form, including one or more data streams or stored in files.

At block 704, the FM functionality 116 causes the processor(s) (e.g., the GPU(s) 108) to perform the latent sequence generation process 412 to produce the latent sequence of vectors (e.g., the latent sequence 406 of vectors) based at least in part on the set of latent representations obtained at block 702. For example, at block 704, the latent sequence generation process 412 may perform the alignment process 340, the fusion process 344, and/or the linear layer 348.

At block 706, the FM functionality 116 causes the processor(s) (e.g., the GPU(s) 108) to provide the latent sequence of vectors obtained at block 704 to a neural network (e.g., the neural network backbone 402), which generates a new latent representation (e.g., a new latent sequence of vectors) based at least in part on the latent sequence of vectors obtained at block 704.

At block 708, the FM functionality 116 causes the processor(s) (e.g., the GPU(s) 108) to provide the new latent representation obtained at block 706 to the reconstruction head 420, and the reconstruction head 420 predicts a reconstructed sequence of vectors (e.g., the reconstructed sequence 422).

At block 710, the FM functionality 116 calculates a loss value (using a loss function) based at least in part on results of a comparison of the reconstructed sequence of vectors to a ground truth sequence. The ground truth sequence is the latent sequence of vectors obtained at block 704.

At decision block 712, the FM functionality 116 determines whether sufficient training iterations have been performed. The decision at decision block 712 is “YES,” when the FM functionality 116 is finished performing training iterations. Otherwise, the decision at decision block 712 is “NO.” When the decision at decision block 712 is “NO,” at block 714, the FM functionality 116 modifies one or more parameters of the FM node (e.g., weights of the neural network (e.g., the neural network backbone 402), and returns to block 706 to perform another iteration. On the other hand, when the decision at decision block 712 is “YES,” at block 716, the FM functionality 116 selects the parameter(s) of the FM mode (e.g., weights of the neural network (e.g., the neural network backbone 402) that output the latent representation that resulted in the smallest loss value. The FM functionality 116 may configure the neural network using the parameters selected at block 716. The training method 700 may terminate after block 716.

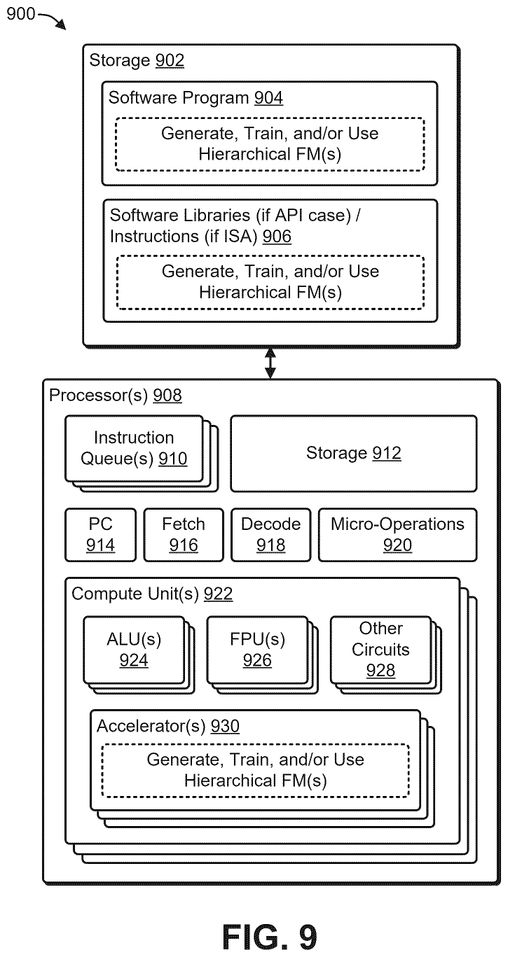

FIG. 8 illustrates an example of a system 800 that includes one or more drivers and/or one or more runtimes (illustrated as reference numeral 804) including one or more libraries 806 to provide one or more application programming interfaces (“API(s)”) 810, in accordance with at least one embodiment. In at least one embodiment, the system 800 includes the driver(s) 804 and/or the runtime(s) 804 including the library(ies) 806 to provide to the API(s) 810. In at least one embodiment, the API(s) 810 is/are sets of software instructions that, if executed, cause one or more processors (e.g., processor(s) 908 illustrated in FIG. 9) to perform one or more computational operations. In at least one embodiment, one or more of the API(s) 810 is/are distributed or otherwise provided as a part of one or more of the library(ies) 806, one or more of the runtime(s) 804, one or more of the driver(s) 804, and/or one or more component of any other grouping of software and/or executable code further described herein. In at least one embodiment, one or more of the API(s) 810 perform one or more computational operations in response to invocation by one or more software programs 802.

In at least one embodiment, one or more of the software program(s) 802 is/are a software module and/or include(s) one or more software modules. In at least one embodiment, a software module is as further illustrated non-exclusively in FIG. 9 as a software program 904 (or component thereof) and described with respect thereto. In at least one embodiment, one or more of the software program(s) 802 is/are a collection of software code, commands, instructions, and/or other sequences of text to instruct a computing device (e.g., one or more of the server(s) 104) to perform one or more computational operations and/or invoke one or more other sets of instructions, such as the API(s) 810 or API function(s) 812, to be executed by the computing device. In at least one embodiment, the functions 812 generate, use, and/or train hierarchical FM(s) (such as the tree FM 200), perform the inference process 310, perform the inference process 330, perform the training process 400, perform the method 500, perform the training method 600, perform the training method 700, and/or otherwise perform any of the operations described herein. In at least one embodiment, functionality provided by one or more of the API(s) 810 includes the API function(s) 812, such as those usable to accelerate one or more portions of the software program(s) 802 using one or more parallel processing units (PPUs), such as graphics processing units (GPUs).

In at least one embodiment, one or more of the API(s) 810 is/are one or more hardware interfaces to one or more circuits to perform one or more computational operations. In at least one embodiment, one or more of the API(s) 810 described herein are implemented as one or more circuits to perform one or more techniques described in connection with FIGS. 1-7. In at least one embodiment, one or more of the software program(s) 802 include instructions that, if executed, cause one or more hardware devices and/or circuits to perform one or more techniques further described in connection with FIGS. 1-7. In at least one embodiment, the system 800 includes one or more or all components of the data system 100 and/or at least one of the server(s) 104 described in relation to FIG. 1, and the system 800 may perform one or more or all of the processes and/or operations that the systems and components of the data center 100 and/or one or more of the server(s) 104 perform.

In at least one embodiment, the software program(s) 802, such as user-implemented software programs, utilize one or more of the API(s) 810 to perform various computing operations, such as memory reservation, matrix multiplication, arithmetic operations, and/or any computing operation performed by PPUs, such as GPUs, as further described herein. In at least one embodiment, the function(s) 812 include a set of callable functions provided by one or more of the API(s) 810 that are referred to herein as APIs, API functions, software functions, and/or functions, that individually perform one or more computing operations, such as computing operations related to parallel computing. In at least one embodiment, one or more of the API(s) 810 generate, use, and/or train hierarchical FM(s) (such as the tree FM 200), perform the inference process 310, perform the inference process 330, perform the training process 400, perform the method 500, perform the training method 600, perform the training method 700, and/or perform other operations described herein (e.g., in connection with FIGS. 1-7).

In at least one embodiment, one or more of the software program(s) 802 interact or otherwise communicate with one or more of the API(s) 810 to perform one or more computing operations using one or more processors (e.g., processor(s) 908 illustrated in FIG. 9), such as one or more PPUs, such as GPUs. In at least one embodiment, one or more computing operations using one or more PPUs include at least one or more groups of computing operations to be accelerated by execution at least in part by said one or more PPUs. In at least one embodiment, one or more of the software program(s) 802 interact with one or more of the API(s) 810 to generate, use, and/or train hierarchical FM(s) (such as the tree FM 200), perform the inference process 310, perform the inference process 330, perform the training process 400, perform the method 500, perform the training method 600, perform the training method 700, and/or perform other operations described herein (e.g., in connection with FIGS. 1-7).

In at least one embodiment, an interface is software instructions that, if executed, provide access to one or more of the function(s) 812 provided by one or more of the API(s) 810. In at least one embodiment, one or more of the software program(s) 802 use(s) a local interface when a software developer compiles one or more of the software program(s) 802 in conjunction with one or more of the library(ies) 806 including or otherwise providing access to one or more of the API(s) 810. In at least one embodiment, one or more of the software program(s) 802 is/are compiled statically in conjunction with one or more pre-compiled ones of the library(ies) 806 and/or uncompiled source code including instructions to perform one or more of the API(s) 810. In at least one embodiment, one or more of the software program(s) 802 are compiled dynamically and the dynamically compiled software program(s) utilize a linker to link to one or more pre-compiled ones of the library(ies) 806, including one or more of the API(s) 810.

In at least one embodiment, one or more of the software program(s) 802 use(s) a remote interface when a software developer executes a software program that utilizes or otherwise communicates with at least one of the library(ies) 806 including one or more of the API(s) 810 over a network or other remote communication medium. In at least one embodiment, one or more of the library(ies) 806 including one or more of the API(s) 810 are to be performed by a remote computing service, such as a computing resource services provider. In at least one embodiment, one or more of the library(ies) 806 including one or more particular APIs (of the API(s) 810) is/are to be performed by any other computing host providing the particular API(s) to one or more of the software program(s) 802.

In at least one embodiment, a processor (e.g., processor(s) 908 illustrated in FIG. 9) performing or using one or more particular ones of the software program(s) 802 calls, uses, performs, and/or otherwise implements one or more of the API(s) 810 to allocate and otherwise manage memory 814 to be used by the particular software program(s). In at least one embodiment, one or more particular ones of the software program(s) 802 utilize one or more of the API(s) 810 to allocate and otherwise manage the memory 814 to be used by one or more portions of the particular software program(s) to be accelerated using one or more PPUs, such as GPUs, or any other accelerator or processor further described herein. In at least one embodiment, one or more of the software program(s) 802 request one or more neural networks to perform signal processing using one or more of the function(s) 812 provided by one or more of the API(s) 810. In at least one embodiment, the storage 110 and/or the memory 112 implement(s) memory 814.

In at least one embodiment, one or more of the API(s) 810 is an API to facilitate parallel computing. In at least one embodiment, one or more of the API(s) 810 is any other API further described herein. In at least one embodiment, one or more of the API(s) 810 is/are provided by one or more of the driver(s) 804 and/or one or more of the runtime(s) 804. In at least one embodiment, one or more of the API(s) 810 is/are provided by a CUDA user-mode driver. In at least one embodiment, one or more of the API(s) 810 is/are provided by a CUDA runtime. In at least one embodiment, one or more of the driver(s) 804 is/are data values and software instructions that, if executed, perform and/or otherwise facilitate operation of one or more of the function(s) 812 of one or more of the API(s) 810 during load and execution of one or more portions of at least one of the software program(s) 802. In at least one embodiment, one or more of the runtime(s) 804 is/are data values and/or software instructions that, if executed, perform or otherwise facilitate operation of one or more of the function(s) 812 of one or more of the API(s) 810 during execution of at least one of the software program(s) 802. In at least one embodiment, one or more particular ones of the software program(s) 802 utilize one or more of the API(s) 810 implemented and/or otherwise provided by one or more of the driver(s) 804 and/or one or more of the runtime(s) 804 to perform combined arithmetic operations by the particular software program(s) during execution by one or more PPUs, such as GPUs.

In at least one embodiment, one or more of the software program(s) 802 utilize one or more of the API(s) 810 provided by one or more of the driver(s) 804 and/or one or more of the runtime(s) 804 to perform combined arithmetic operations of one or more PPUs, such as GPUs. In at least one embodiment, one or more of the API(s) 810 provide combined arithmetic operations through one or more of the driver(s) 804 and/or one or more of the runtime(s) 804, as described above. In at least one embodiment, one or more of the software program(s) 802 utilize one or more of the API(s) 810 provided by one or more of the driver(s) 804 and/or one or more of the runtime(s) 804 to allocate or otherwise reserve one or more blocks of the memory 814 of one or more PPUs, such as GPUs. In at least one embodiment, one or more of the software program(s) 802 utilize one or more of the API(s) 810 provided by one or more of the driver(s) 804 and/or one or more of the runtime(s) 804 to allocate or otherwise reserve blocks of the memory 814.

In at least one embodiment, to improve usability of one or more particular ones of the software program(s) 802 and/or improve performance, one or more portions of the particular software programs are to be accelerated by one or more PPUs (such as GPUs). In at least one embodiment, one or more of the function(s) 812 receive one or more input parameters indicating one or more inputs to one or more neural networks and/or other data to be utilized by the neural network(s), such as one or more hyperparameters of the neural network(s). In at least one embodiment, the input parameter(s) include the one or more inputs and/or the other data. In at least one embodiment, the input parameter(s) include one or more pointers to one or more memory locations where the input(s) and/or the other data is/are stored.

In at least one embodiment, the system 800 includes at least one processor (e.g., processor(s) 908 illustrated in FIG. 9) including one or more circuits to perform one or more software programs to combine two or more of the API(s) 810 into a single API. In at least one embodiment, the system 800 includes at least one processor (e.g., processor(s) 908 illustrated in FIG. 9) that uses one or more of the API(s) 810 to generate, use, and/or train hierarchical FM(s) (such as the tree FM 200), perform the inference process 310, perform the inference process 330, perform the training process 400, perform the method 500, perform the training method 600, perform the training method 700, and/or otherwise perform operations described herein. In at least one embodiment, the system 800 includes at least one processor (e.g., processor(s) 908 illustrated in FIG. 9) that uses one or more of the API(s) 810 to perform one or more operations illustrated in and/or described with respect to one or more of FIGS. 1-7, such as one or more processes illustrated in FIGS. 1-7 or portion(s) thereof. In at least one embodiment, the system 800 includes at least one processor (e.g., processor(s) 908 illustrated in FIG. 9) to perform one or more of the function(s) 812, such as those described in connection with FIGS. 1-7. In at least one embodiment, one or more of the API(s) 810 is to be performed by hardware described in connection with FIGS. 9-12.

FIG. 9 illustrates an example of a system 900 that can include software and hardware to use a plurality of machine learning processes (e.g., included in FM nodes) arranged hierarchically to generate at least one latent representation of two or more input data streams, perform one or more tasks based, at least in part, on the at least one latent representation, or otherwise perform any of the operations described herein, according to at least one embodiment. For example, the software and hardware of the system 900 may generate, use, and/or train hierarchical FM(s) (such as the tree FM 200), perform the inference process 310, perform the inference process 330, perform the training process 400, perform the method 500, perform the training method 600, perform the training method 700, and/or otherwise perform operations described herein. System 900 can include storage 902 and processor(s) 908. Storage 902 can include, for example, memory, cache, or other storage described further herein. Storage 902 can be separate from processor(s) 908, or storage 902 can be included in processor(s) 908 (e.g., in storage 912). In at least one embodiment, software program 904 and/or software libraries (or instructions) 906 can be stored in memory, cache, or other storage and provided to processor(s) 908 to cause one or more circuits of processor(s) 908 to perform operations described herein. In at least one embodiment, software program 904 and/or software libraries (or instructions) 906 can be integrated into one or more circuits of processor(s) 908. Software program 904, which can be used to perform any of the operations described herein, may be stored on storage 902.

In at least one embodiment, software program 904 can include one or more software modules. The software modules may implement the FM functionality 116 (e.g., by storing instructions to at least partially implement the FM functionality 116), generate, use, and/or train hierarchical FM(s) (such as the tree FM 200), perform the inference process 310, perform the inference process 330, perform the training process 400, perform the method 500, perform the training method 600, perform the training method 700, and/or otherwise perform operations described herein. In at least one embodiment, the software modules implement a computer-implemented method that includes generating a latent sequence of vectors by aligning and merging at least two latent representations obtained based at least in part on two or more input data streams, using at least one neural network to generate at least one latent representation based, at least in part, on the latent sequence of vectors, performing one or more tasks based, at least in part, on the at least one latent representation, and/or otherwise perform operations described herein.

In at least one embodiment, as used in any implementation described herein, unless otherwise clear from context or stated explicitly to contrary, a module refers to any combination of software logic, firmware logic, hardware logic, and/or circuitry configured to provide functionality described herein. In at least one embodiment, software is embodied as a software package, code and/or instruction set or instructions, and “hardware,” as used in any implementation described herein, includes, for example, singly or in any combination, hardwired circuitry, programmable circuitry, state machine circuitry, fixed function circuitry, execution unit circuitry, and/or firmware that stores instructions performed by programmable circuitry. In at least one embodiment, modules are, collectively or individually, embodied as circuitry that forms part of a larger system, for example, an integrated circuit (IC), system on-chip (SoC), and so forth. In at least one embodiment, a module performs one or more processes in connection with any suitable processing unit and/or combination of processing units, such as one or more CPUs, GPUs, GPGPUs, PPUs, and/or variations thereof including those further described herein.

In at least one embodiment, software program 904 can include a collection of software code, commands, instructions, or other sequences of text to instruct a computing device to perform one or more computational operations and/or invoke one or more other sets of instructions, such as API(s) or API function(s) or Instruction Set Architecture (ISA) level instructions, to be executed or otherwise performed. Instructions (e.g., hardware instructions) or microcode can involve ISA level instructions, which can include native ISA instructions or non-native ISA instructions. Software program 904 and/or software libraries (or instructions) 906 (e.g., one or more modules) can be distributed among multiple processors that communicate over a bus, network, by writing to shared memory, and/or any suitable communication process such as those described herein.

In at least one embodiment, system 900 can include one or more software libraries 906 that can, for example, provide one or more APIs and/or ISA instructions. In at least one embodiment, one or more APIs and/or ISA instructions can be used to generate, use, and/or train hierarchical FM(s) (such as the tree FM 200), perform the inference process 310, perform the inference process 330, perform the training process 400, perform the method 500, perform the training method 600, perform the training method 700, and/or otherwise perform operations described herein. In at least one embodiment, one or more software libraries 906 can be included in drivers and/or runtimes. In at least one embodiment, software libraries 906 (e.g., including one or more APIs and/or ISA instructions) can include sets of software instructions that, if executed or otherwise performed, cause processor(s) 908 to perform one or more computational operations, such as any of the operations described herein. In at least one embodiment, one or more APIs and/or ISA instructions can be distributed or otherwise provided as a part of one or more software libraries 906, runtimes, drivers, and/or any other grouping of software and/or executable code further described herein. In at least one embodiment, one or more APIs and/or ISA instructions can perform one or more computational operations in response to invocation by software program 904.

Processor(s) 908 may include any number of processors and any suitable processing unit and/or combination of processing units, such as, but not limited to, central processing units (“CPUs”), graphics processing units (“GPUs”), or other processors (including accelerators, field programmable gate arrays (FPGAs), graphics processors, parallel processors, GPGPUs, DPUs, and/or variations thereof including those further described herein), including any processors described herein, such as, but not limited to, processors in FIGS. 9-12. In at least one embodiment, processor(s) 908 can retrieve or fetch instructions (e.g., one or more APIs and/or ISA instructions) from storage 902 using, for example, instruction fetch 916 (e.g., for an Instruction Fetch stage). Instructions can include instructions to generate, use, and/or train hierarchical FM(s) (such as the tree FM 200), perform the inference process 310, perform the inference process 330, perform the training process 400, perform the method 500, perform the training method 600, perform the training method 700, and/or otherwise perform operations described herein. In at least one embodiment, processor(s) 908 can include storage 912 and instruction queue 910 to store and queue instructions fetched from storage 902. In at least one embodiment, fetched instructions can be decoded by decode 918 to determine what operation should be performed by processor(s) 908 (e.g., in an Instruction Decode stage). In at least one embodiment, processor(s) 908 can fetch additional operands (data) that may be used for instructions, and operands can be stored, e.g., in registers or storage 912. In at least one embodiment, micro-operations 920 can perform operations on data stored in one or more registers or storage 912. For example, each step of instructions fetched by processor(s) 908 can be decomposed during execution so processor(s) 908 can execute instructions in steps through a series of micro-operations 920. In at least one embodiment, program counter (PC) 914 can hold an address for a next instruction and can be updated to point to the next instruction to be executed by processor(s) 908.

In at least one embodiment, processor(s) 908 can perform instructions (e.g., in an Execution stage). For example, processor(s) 908 can perform an operation specified by the instructions, such as an arithmetic operation, a logical operation, or a data transfer. In at least one embodiment, compute unit(s) 922 can execute instructions to perform any of the operations described herein. In at least one embodiment, compute unit(s) can include ALU(s) 924 (Arithmetic Logic Units), which may be used for performing arithmetic and logical operations. In at least one embodiment, compute unit(s) can include FPU(s) (Floating Point Units) 926, which may be used for performing floating-point calculations. In at least one embodiment, other circuits 928 can be used to perform other operations, such as vector and/or scalar operations. In at least one embodiment, accelerator(s) 930 can include one or more matrix multiplication accelerators, one or more parallel processing units (PPUs), such as GPUs, or any other accelerator or processor further described herein. In at least one embodiment, software program 904 can utilize one or more APIs and/or ISA instructions to perform various computing operations with accelerator(s) 930, such as matrix multiplication, arithmetic operations, or any other computing operation further described herein. In at least one embodiment, one or more computing operations using accelerator(s) 930 can include at least one or more groups of computing operations to be accelerated by execution at least in part by accelerator(s) 930, including to generate, use, and/or train hierarchical FM(s) (such as the tree FM 200), perform the inference process 310, perform the inference process 330, perform the training process 400, perform the method 500, perform the training method 600, perform the training method 700, and/or otherwise perform operations described herein.

In at least one embodiment, system 900 can be used to perform one or more instructions that include functions or operations, such as those described in connection with FIGS. 1-12. In at least one embodiment, system 900 including one or more processors including one or more circuits to use a plurality of neural networks arranged hierarchically to generate at least one latent representation of two or more input data streams having different modalities, generate hierarchical FM(s) (such as the tree FM 200), use hierarchical FM(s) (such as the tree FM 200), train hierarchical FM(s) (such as the tree FM 200), perform the inference process 310, perform the inference process 330, perform the training process 400, perform the method 500, perform the training method 600, perform the training method 700, and/or otherwise perform operations described herein. In at least one embodiment, system 900 is included in and/or otherwise includes systems illustrated in FIGS. 1-12 to cause one or more circuits to use a plurality of neural networks arranged hierarchically to generate at least one latent representation of two or more input data streams having different modalities, generate hierarchical FM(s) (such as the tree FM 200), use hierarchical FM(s) (such as the tree FM 200), train hierarchical FM(s) (such as the tree FM 200), perform the inference process 310, perform the inference process 330, perform the training process 400, perform the method 500, perform the training method 600, perform the training method 700, and/or otherwise perform operations described herein. In at least one embodiment, system 900 includes one or more hardware illustrated in FIGS. 1-12, such as to use a plurality of neural networks arranged hierarchically to generate at least one latent representation of two or more input data streams having different modalities, generate hierarchical FM(s) (such as the tree FM 200), use hierarchical FM(s) (such as the tree FM 200), train hierarchical FM(s) (such as the tree FM 200), perform the inference process 310, perform the inference process 330, perform the training process 400, perform the method 500, perform the training method 600, perform the training method 700, and/or otherwise perform operations described herein.

LOGIC

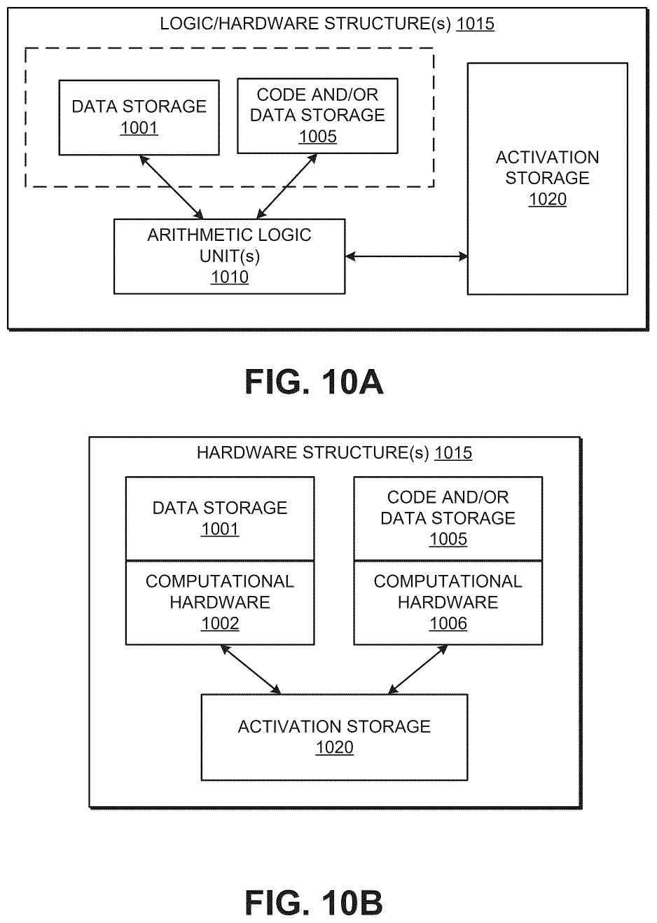

FIG. 10A illustrates logic 1015 which, as described elsewhere herein, can be used in one or more devices to perform operations such as those discussed herein in accordance with at least one embodiment. In at least one embodiment, logic 1015 is used to perform inferencing and/or training operations associated with one or more embodiments. In at least one embodiment, logic 1015 is inference and/or training logic. Details regarding logic 1015 are provided below in conjunction with FIGS. 10A and/or 10B. In at least one embodiment, logic refers to any combination of software logic, hardware logic, and/or firmware logic to provide functionality or operations described herein, wherein logic may be, collectively or individually, embodied as circuitry that forms part of a larger system, for example, an integrated circuit (IC), system-on-chip (SoC), or one or processors (e.g., CPU, GPU).

In at least one embodiment, logic 1015 may include, without limitation, code and/or data storage 1001 to store forward and/or output weight and/or input/output data, and/or other parameters to configure neurons or layers of a neural network trained and/or used for inferencing in aspects of one or more embodiments. In at least one embodiment, logic 1015 may include, or be coupled to code and/or data storage 1001 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment, code and/or data storage 1001 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 1001 may be included with other on-chip or off-chip data storage, including a processor's L1, L2, or L3 cache or system memory.

In at least one embodiment, any portion of code and/or data storage 1001 may be internal or external to one or more processors or other hardware logic devices or circuits. In at least one embodiment, code and/or code and/or data storage 1001 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 1001 is internal or external to a processor, for example, or including DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, logic 1015 may include, without limitation, a code and/or data storage 1005 to store backward and/or output weight and/or input/output data corresponding to neurons or layers of a neural network trained and/or used for inferencing in aspects of one or more embodiments. In at least one embodiment, code and/or data storage 1005 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, logic 1015 may include, or be coupled to code and/or data storage 1005 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 1005 may be included with other on-chip or off-chip data storage, including a processor's L1, L2, or L3 cache or system memory. In at least one embodiment, any portion of code and/or data storage 1005 may be internal or external to one or more processors or other hardware logic devices or circuits. In at least one embodiment, code and/or data storage 1005 may be cache memory, DRAM, SRAM, non-volatile memory (e.g., flash memory), or other storage. In at least one embodiment, a choice of whether code and/or data storage 1005 is internal or external to a processor, for example, or including DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 1001 and code and/or data storage 1005 may be separate storage structures. In at least one embodiment, code and/or data storage 1001 and code and/or data storage 1005 may be a combined storage structure. In at least one embodiment, code and/or data storage 1001 and code and/or data storage 1005 may be partially combined and partially separate. In at least one embodiment, any portion of code and/or data storage 1001 and code and/or data storage 1005 may be included with other on-chip or off-chip data storage, including a processor's L1, L2, or L3 cache or system memory.

In at least one embodiment, logic 1015 may include, without limitation, one or more arithmetic logic unit(s) (“ALU(s)”) 1010, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 1020 that are functions of input/output and/or weight parameter data stored in code and/or data storage 1001 and/or code and/or data storage 1005. In at least one embodiment, activations stored in activation storage 1020 are generated according to linear algebraic and or matrix-based mathematics performed by ALU(s) 1010 in response to performing instructions or other code, wherein weight values stored in code and/or data storage 1005 and/or data storage 1001 are used as operands along with other values, such as bias values, gradient information, momentum values, or other parameters or hyperparameters, any or all of which may be stored in code and/or data storage 1005 or code and/or data storage 1001 or another storage on or off-chip.

In at least one embodiment, ALU(s) 1010 are included within one or more processors or other hardware logic devices or circuits, whereas in another embodiment, ALU(s) 1010 may be external to a processor or other hardware logic device or circuit that uses them (e.g., a co-processor). In at least one embodiment, ALUs 1010 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 1001, code and/or data storage 1005, and activation storage 1020 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 1020 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 1020 may be cache memory, DRAM, SRAM, non-volatile memory (e.g., flash memory), or other storage. In at least one embodiment, activation storage 1020 may be completely or partially within or external to one or more processors or other logical circuits. In at least one embodiment, a choice of whether activation storage 1020 is internal or external to a processor, for example, or including DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, logic 1015 illustrated in FIG. 10A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, logic 1015 illustrated in FIG. 10A may be used in conjunction with central processing unit (“CPU”) hardware, graphics processing unit (“GPU”) hardware or other hardware, such as field programmable gate arrays (“FPGAs”).

FIG. 10B illustrates logic 1015, according to at least one embodiment. In at least one embodiment, logic 1015 is inference and/or training logic. In at least one embodiment, logic 1015 may include, without limitation, hardware logic in which computational resources are dedicated or otherwise exclusively used in conjunction with weight values or other information corresponding to one or more layers of neurons within a neural network. In at least one embodiment, logic 1015 illustrated in FIG. 10B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, logic 1015 illustrated in FIG. 10B may be used in conjunction with central processing unit (CPU) hardware, graphics processing unit (GPU) hardware or other hardware, such as field programmable gate arrays (FPGAs). In at least one embodiment, logic 1015 includes, without limitation, code and/or data storage 1001 and code and/or data storage 1005, which may be used to store code (e.g., graph code), weight values and/or other information, including bias values, gradient information, momentum values, and/or other parameter or hyperparameter information. In at least one embodiment illustrated in FIG. 10B, each of code and/or data storage 1001 and code and/or data storage 1005 is associated with a dedicated computational resource, such as computational hardware 1002 and computational hardware 1006, respectively. In at least one embodiment, each of computational hardware 1002 and computational hardware 1006 includes one or more ALUs that perform mathematical functions, such as linear algebraic functions, only on information stored in code and/or data storage 1001 and code and/or data storage 1005, respectively, result of which is stored in activation storage 1020.

In at least one embodiment, each of code and/or data storage 1001 and 1005 and corresponding computational hardware 1002 and 1006, respectively, correspond to different layers of a neural network, such that resulting activation from one storage/computational pair 1001/1002 of code and/or data storage 1001 and computational hardware 1002 is provided as an input to a next storage/computational pair 1005/1006 of code and/or data storage 1005 and computational hardware 1006, in order to mirror a conceptual organization of a neural network. In at least one embodiment, each of storage/computational pairs 1001/1002 and 1005/1006 may correspond to more than one neural network layer. In at least one embodiment, additional storage/computation pairs (not shown) subsequent to or in parallel with storage/computation pairs 1001/1002 and 1005/1006 may be included in logic 1015.

The logic 1015 may generate hierarchical FM(s) (such as the tree FM 200), use hierarchical FM(s) (such as the tree FM 200), train hierarchical FM(s) (such as the tree FM 200), perform the inference process 310, perform the inference process 330, perform the training process 400, perform the method 500, perform the training method 600, perform the training method 700, and/or otherwise perform operations described herein.

### DATA CENTER

FIG. 11 illustrates an example data center 1100, in which at least one embodiment may be used. In at least one embodiment, data center 1100 includes a data center infrastructure layer 1110, a framework layer 1120, a software layer 1130 and an application layer 1140.

In at least one embodiment, as shown in FIG. 11, data center infrastructure layer 1110 may include a resource orchestrator 1112, grouped computing resources 1114, and node computing resources (“node C.R.s”) 1116(1)-1116(N), where “N” represents a positive integer (which may be a different integer “N” than used in other figures). In at least one embodiment, node C.R.s 1116(1)-1116(N) may include, but are not limited to, any number of central processing units (“CPUs”) or other processors (including accelerators, field programmable gate arrays (FPGAs), graphics processors, etc.), memory storage devices 1118(1)-1118(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 1116(1)-1116(N) may be a server having one or more of above-mentioned computing resources.

In at least one embodiment, grouped computing resources 1114 may include separate groupings of node C.R.s housed within one or more racks (not shown), or many racks housed in data centers at various geographical locations (also not shown). In at least one embodiment, separate groupings of node C.R.s within grouped computing resources 1114 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 1112 may configure or otherwise control one or more node C.R.s 1116(1)-1116(N) and/or grouped computing resources 1114. In at least one embodiment, resource orchestrator 1112 may include a software design infrastructure (“SDI”) management entity for data center 1100. In at least one embodiment, resource orchestrator 1112 may include hardware, software or some combination thereof.

In at least one embodiment, as shown in FIG. 11, framework layer 1120 includes a job scheduler 1122, a configuration manager 1124, a resource manager 1126 and a distributed file system 1128. In at least one embodiment, framework layer 1120 may include a framework to support software 1132 of software layer 1130 and/or one or more application(s) 1142 of application layer 1140. In at least one embodiment, software 1132 or application(s) 1142 may respectively include web-based service software or applications, such as those provided by Amazon Web Services, Google Cloud and Microsoft Azure. In at least one embodiment, framework layer 1120 may be, but is not limited to, a type of free and open-source software web application framework such as Apache Spark™ (hereinafter “Spark”) that may utilize distributed file system 1128 for large-scale data processing (e.g., “big data”). In at least one embodiment, job scheduler 1122 may include a Spark driver to facilitate scheduling of workloads supported by various layers of data center 1100. In at least one embodiment, configuration manager 1124 may be capable of configuring different layers such as software layer 1130 and framework layer 1120 including Spark and distributed file system 1128 for supporting large-scale data processing. In at least one embodiment, resource manager 1126 may be capable of managing clustered or grouped computing resources mapped to or allocated for support of distributed file system 1128 and job scheduler 1122. In at least one embodiment, clustered or grouped computing resources may include grouped computing resources 1114 at data center infrastructure layer 1110. In at least one embodiment, resource manager 1126 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1128 of framework layer 1120. In at least one embodiment, one or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1128 of framework layer 1120. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 1124, resource manager 1126, and resource orchestrator 1112 may implement any number and type of self-modifying actions based on any amount and type of data acquired in any technically feasible fashion. In at least one embodiment, self-modifying actions may relieve a data center operator of data center 1100 from making possibly bad configuration decisions and possibly avoiding underutilized and/or poor performing portions of a data center.

In at least one embodiment, data center 1100 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 1100. In at least one embodiment, trained machine learning models corresponding to one or more neural networks may be used to infer or predict information using resources described above with respect to data center 1100 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Logic 1015 are used to perform inferencing and/or training operations associated with one or more embodiments. Details regarding logic 1015 are provided herein in conjunction with FIGS. 10A and/or 10B. In at least one embodiment, logic 1015 may be used in data center 1100 for inferencing or predicting operations based, at least in part, on weight parameters calculated using neural network training operations, neural network functions and/or architectures, or neural network use cases described herein.

The data center 1100 may generate hierarchical FM(s) (such as the tree FM 200), use hierarchical FM(s) (such as the tree FM 200), train hierarchical FM(s) (such as the tree FM 200), perform the inference process 310, perform the inference process 330, perform the training process 400, perform the method 500, perform the training method 600, perform the training method 700, and/or otherwise perform operations described herein.

### COMPUTER SYSTEMS

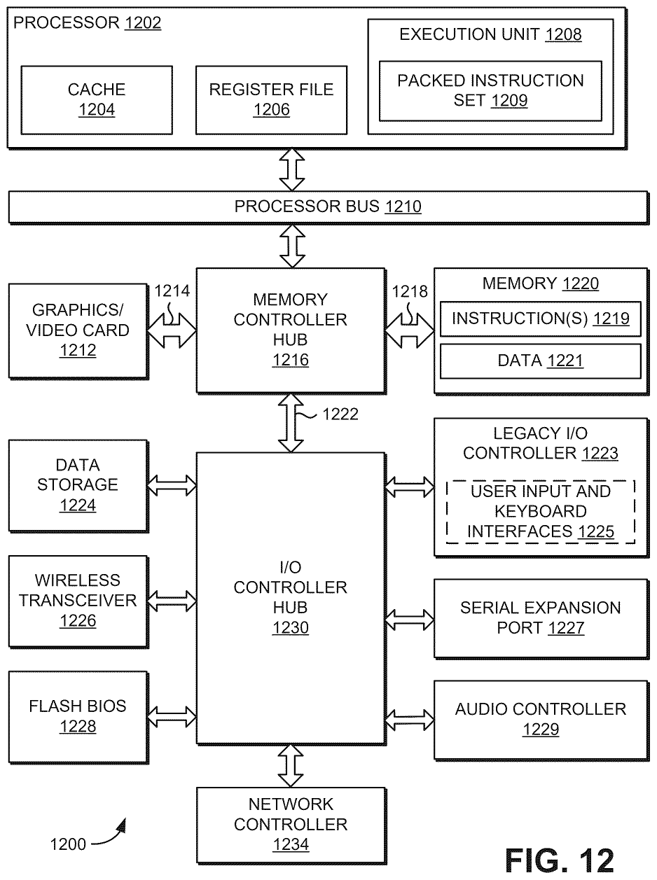

FIG. 12 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 1200 may include, without limitation, a component, such as a processor 1202 to employ execution units including logic to perform algorithms for process data, in accordance with present disclosure, such as in embodiment described herein. In at least one embodiment, computer system 1200 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1200 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 1200 may include, without limitation, processor 1202 that may include, without limitation, one or more execution units 1208 to perform machine learning model training and/or inferencing according to techniques described herein. In at least one embodiment, computer system 1200 is a single processor desktop or server system, but in another embodiment, computer system 1200 may be a multiprocessor system. In at least one embodiment, processor 1202 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 1202 may be coupled to a processor bus 1210 that may transmit data signals between processor 1202 and other components in computer system 1200.

In at least one embodiment, processor 1202 may include, without limitation, a Level 1 (“L1”) internal cache memory (“cache”) 1204. In at least one embodiment, processor 1202 may have a single internal cache or multiple levels of internal cache. In at least one embodiment, cache memory may reside external to processor 1202. Other embodiments may also include a combination of both internal and external caches depending on particular implementation and needs. In at least one embodiment, a register file 1206 may store different types of data in various registers including, without limitation, integer registers, floating point registers, status registers, and an instruction pointer register.

In at least one embodiment, execution unit 1208, including, without limitation, logic to perform integer and floating point operations, also resides in processor 1202. In at least one embodiment, processor 1202 may also include a microcode (“ucode”) read only memory (“ROM”) that stores microcode for certain macro instructions. In at least one embodiment, execution unit 1208 may include logic to handle a packed instruction set 1209. In at least one embodiment, by including packed instruction set 1209 in an instruction set of a general-purpose processor, along with associated circuitry to execute instructions, operations used by many multimedia applications may be performed using packed data in processor 1202. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 1208 may also be used in microcontrollers, embedded processors, graphics devices, DSPs, and other types of logic circuits. In at least one embodiment, computer system 1200 may include, without limitation, a memory 1220. In at least one embodiment, memory 1220 may be a Dynamic Random Access Memory (“DRAM”) device, a Static Random Access Memory (“SRAM”) device, a flash memory device, or another memory device. In at least one embodiment, memory 1220 may store instruction(s) 1219 and/or data 1221 represented by data signals that may be executed by processor 1202.

In at least one embodiment, a system logic chip may be coupled to processor bus 1210 and memory 1220. In at least one embodiment, a system logic chip may include, without limitation, a memory controller hub (“MCH”) 1216, and processor 1202 may communicate with MCH 1216 via processor bus 1210. In at least one embodiment, MCH 1216 may provide a high bandwidth memory path 1218 to memory 1220 for instruction and data storage and for storage of graphics commands, data and textures. In at least one embodiment, MCH 1216 may direct data signals between processor 1202, memory 1220, and other components in computer system 1200 and to bridge data signals between processor bus 1210, memory 1220, and a system I/O interface 1222. In at least one embodiment, a system logic chip may provide a graphics port for coupling to a graphics controller. In at least one embodiment, MCH 1216 may be coupled to memory 1220 through high bandwidth memory path 1218 and a graphics/video card 1212 may be coupled to MCH 1216 through an Accelerated Graphics Port (“AGP”) interconnect 1214.

In at least one embodiment, computer system 1200 may use system I/O interface 1222 as a proprietary hub interface bus to couple MCH 1216 to an I/O controller hub (“ICH”) 1230. In at least one embodiment, ICH 1230 may provide direct connections to some I/O devices via a local I/O bus. In at least one embodiment, a local I/O bus may include, without limitation, a high-speed I/O bus for connecting peripherals to memory 1220, a chipset, and processor 1202. Examples may include, without limitation, an audio controller 1229, a firmware hub (“flash BIOS”) 1228, a wireless transceiver 1226, a data storage 1224, a legacy I/O controller 1223 containing user input and keyboard interfaces 1225, a serial expansion port 1227, such as a Universal Serial Bus (“USB”) port, and a network controller 1234. In at least one embodiment, data storage 1224 may include a hard disk drive, a floppy disk drive, a CD-ROM device, a flash memory device, or other mass storage device.

In at least one embodiment, FIG. 12 illustrates a system, which includes interconnected hardware devices or “chips”, whereas in other embodiments, FIG. 12 may illustrate an exemplary SoC. In at least one embodiment, devices illustrated in FIG. 12 may be interconnected with proprietary interconnects, standardized interconnects (e.g., PCIe) or some combination thereof. In at least one embodiment, one or more components of computer system 1200 are interconnected using compute express link (CXL) interconnects.

Logic 1015 are used to perform inferencing and/or training operations associated with one or more embodiments. Details regarding logic 1015 are provided herein in conjunction with FIGS. 10A and/or 10B. In at least one embodiment, logic 1015 may be used in computer system 1200 for inferencing or predicting operations based, at least in part, on weight parameters calculated using neural network training operations, neural network functions and/or architectures, or neural network use cases described herein.

The processor(s) 105 may include the processor 1202, which may generate hierarchical FM(s) (such as the tree FM 200), use hierarchical FM(s) (such as the tree FM 200), train hierarchical FM(s) (such as the tree FM 200), perform the inference process 310, perform the inference process 330, perform the training process 400, perform the method 500, perform the training method 600, perform the training method 700, and/or otherwise perform operations described herein. The instruction(s) 1219 may include the instructions 114. The memory 1220 and/or the data storage 1224 may include the storage 110 and/or the memory 112.

At least one embodiment of the disclosure can be described in view of the following clauses:

Clause 1. A processor comprising: one or more circuits to at least: use a plurality of neural networks arranged hierarchically to generate at least one latent representation of two or more input data streams having different modalities.

Clause 2. The processor of clause 1, wherein the plurality of neural networks comprise a first set of neural networks to generate a first set of latent representations using the two or more input data streams, and a second set of neural networks to generate a second set of latent representations using the first set of latent representations, the first set of latent representations is to correspond to a first data resolution, and the second set of latent representations is to correspond to a second data resolution that is lower than the first data resolution.

Clause 3. The processor of clause 2, wherein the first data resolution represents different devices in a data center, and the second data resolution represents combinations of two or more of the devices.

Clause 4. The processor of any one of clauses 1-3, wherein the plurality of neural networks are to at least: obtain a plurality of first latent representations based at least in part on the two or more input data streams; align and merge at least two of the plurality of first latent representations to generate a plurality of second latent representations; and align and merge at least two of the plurality of second latent representations to generate the at least one latent representation.

Clause 5. The processor of clause 4, wherein the at least two of the plurality of first latent representations correspond to a same device.

Clause 6. The processor of clause 4 or 5, wherein different portions of the at least two of the plurality of second latent representations correspond to different devices.

Clause 7. The processor of any one of clauses 1-6, wherein the one or more circuits are to at least: generate one or more predictions based, at least in part, on patterns identified from the at least one latent representation.

Clause 8. The processor of any one of clauses 1-7, wherein the two or more input data streams comprise at least one of multimodal data, multivariate data, multicomponent data, or multisource data.

Clause 9. The processor of any one of clauses 1-8, wherein at least one of the plurality of neural networks is to be trained using self supervision.

Clause 10. A computer-implemented method comprising: generating a latent sequence of vectors by aligning and merging at least two latent representations obtained based at least in part on two or more input data streams; using at least one neural network to generate at least one latent representation based, at least in part, on the latent sequence of vectors; and performing one or more tasks based, at least in part, on the at least one latent representation.

Clause 11. The computer-implemented method of clause 10, wherein the two or more input data streams transmit information related to one or more devices in a data center.

Clause 12. The computer-implemented method of clause 10 or 11, wherein the one or more tasks comprise generating one or more predictions based, at least in part, on patterns identified using the at least one latent representation.

Clause 13. The computer-implemented method of any one of clauses 10-12, wherein the two or more input data streams comprise one or more of multimodal data, multivariate data, multicomponent data, or multisource data.

Clause 14. The computer-implemented method of any one of clauses 10-13, further comprising: using self supervision to train the at least one neural network.

Clause 15. A system comprising: one or more processors to at least: use a plurality of machine learning processes arranged hierarchically to generate at least one latent representation of two or more input data streams; and perform one or more tasks based, at least in part, on the at least one latent representation.

Clause 16. The system of clause 15, wherein the plurality of machine learning processes are to at least: obtain a plurality of latent representations based at least in part on the two or more input data streams; and align and merge at least two of the plurality of latent representations to generate the at least one latent representation.

Clause 17. The system of clause 15 or 16, wherein the one or more tasks comprise at least one of detecting one or more anomalies, predicting one or more future events, making one or more decisions, identifying at least one pattern in the two or more input data streams, classifying information, or performing regression.

Clause 18. The system of any one of clauses 15-17, wherein the two or more input data streams transmit information related to one or more devices in a data center.

Clause 19. The system of clause 18, wherein the two or more input data streams comprise at least one of multimodal data, multivariate data, multicomponent data, or multisource data.

Clause 20. The system of any one of clauses 15-19, wherein the plurality of machine learning processes are a first plurality of machine learning processes that define a first hierarchical structure, a second plurality of machine learning processes define a second hierarchical structure, a third plurality of machine learning processes define a third hierarchical structure, the third hierarchical structure to receive outputs of the first and second hierarchical structures as inputs, together the first, second, and third hierarchical structures forming at least part of a combined structure, the combined structure to be trained using at least one of supervised learning or unsupervised learning.

In at least one embodiment, a single semiconductor platform may refer to a sole unitary semiconductor-based integrated circuit or chip. In at least one embodiment, multi-chip modules may be used with increased connectivity which simulate on-chip operation, and make substantial improvements over utilizing a conventional central processing unit (“CPU”) and bus implementation. In at least one embodiment, various modules may also be situated separately or in various combinations of semiconductor platforms per desires of user.

In at least one embodiment, computer programs in form of machine-readable executable code or computer control logic algorithms are stored in main memory and/or secondary storage such as those described herein. Computer programs, if executed by one or more processors, enable at least one system described herein to perform various functions in accordance with at least one embodiment. In at least one embodiment, memory, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of a CPU such as those described herein, a parallel processing system such as those described herein, an integrated circuit capable of at least a portion of capabilities of both the CPU, the parallel processing system, a chipset (e.g., a group of integrated circuits designed to work and sold as a unit for performing related functions, etc.), and/or any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, a computer system described herein may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic. In at least one embodiment, a computer system includes or refers to any devices illustrated in any of the drawings and/or described herein.

In at least one embodiment, a parallel processing system includes, without limitation, a plurality of parallel processing units (“PPUs”) and associated memories. In at least one embodiment, PPUs are connected to a host processor or other peripheral devices via an interconnect and a switch or multiplexer. In at least one embodiment, a parallel processing system distributes computational tasks across the PPUs, which can be parallelizable—for example, as part of distribution of computational tasks across multiple graphics processing unit (“GPU”) thread blocks. In at least one embodiment, memory is shared and accessible (e.g., for read and/or write access) across some or all of the PPUs, although such shared memory may incur performance penalties relative to use of local memory and registers resident to a PPU. In at least one embodiment, operation of the PPUs is synchronized through use of a command such as __syncthreads( ), wherein all threads in a block (e.g., executed across multiple PPUs) to reach a certain point of execution of code before proceeding.

In at least one embodiment, one or more techniques described herein utilize a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model utilizes a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oneAPI and/or oneAPI programming model is utilized to interact with various accelerator, GPU, processor, and/or variations thereof, architectures. In at least one embodiment, oneAPI includes a set of libraries that implement various functionalities. In at least one embodiment, oneAPI includes at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is utilized for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as oneVPL, is a library that is utilized for accelerating video processing in one or more applications. In at least one embodiment, oneVPL implements various video decoding, encoding, and processing functions. In at least one embodiment, oneVPL implements various functions for media pipelines on CPUs, GPUs, and other accelerators. In at least one embodiment, oneVPL implements device discovery and selection in media centric and video analytics workloads. In at least one embodiment, oneVPL implements API primitives for zero-copy buffer sharing.

In at least one embodiment, a oneAPI programming model utilizes a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

In at least one embodiment, any application programming interface (API) described herein is compiled into one or more instructions, operations, or any other signal by a compiler, interpreter, or other software tool. In at least one embodiment, compilation includes generating one or more machine-executable instructions, operations, or other signals from source code. In at least one embodiment, an API compiled into one or more instructions, operations, or other signals, when performed, causes one or more processors, such as graphics processors, graphics cores, parallel processor, a CPU, or any other logic circuit further described herein to perform one or more computing operations.

It should be noted that, while example embodiments described herein may relate to a CUDA programming model, techniques described herein can be utilized with any suitable programming model, such HIP, oneAPI, and/or variations thereof.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor comprising:
one or more circuits to at least:
use a plurality of neural networks arranged hierarchically to generate at least one latent representation of two or more input data streams having different modalities.

2. The processor of claim 1, wherein the plurality of neural networks comprise a first set of neural networks to generate a first set of latent representations using the two or more input data streams, and a second set of neural networks to generate a second set of latent representations using the first set of latent representations,
the first set of latent representations is to correspond to a first data resolution, and
the second set of latent representations is to correspond to a second data resolution that is lower than the first data resolution.

3. The processor of claim 2, wherein the first data resolution represents different devices in a data center, and the second data resolution represents combinations of two or more of the devices.

4. The processor of claim 1, wherein the plurality of neural networks are to at least:
obtain a plurality of first latent representations based at least in part on the two or more input data streams;
align and merge at least two of the plurality of first latent representations to generate a plurality of second latent representations; and
align and merge at least two of the plurality of second latent representations to generate the at least one latent representation.

5. The processor of claim 4, wherein the at least two of the plurality of first latent representations correspond to a same device.

6. The processor of claim 4, wherein different portions of the at least two of the plurality of second latent representations correspond to different devices.

7. The processor of claim 1, wherein the one or more circuits are to at least:
generate one or more predictions based, at least in part, on patterns identified from the at least one latent representation.

8. The processor of claim 1, wherein the two or more input data streams comprise at least one of multimodal data, multivariate data, multicomponent data, or multisource data.

9. The processor of claim 1, wherein at least one of the plurality of neural networks is to be trained using self supervision.

10. A computer-implemented method comprising:
generating a latent sequence of vectors by aligning and merging at least two latent representations obtained based at least in part on two or more input data streams;
using at least one neural network to generate at least one latent representation based, at least in part, on the latent sequence of vectors; and
performing one or more tasks based, at least in part, on the at least one latent representation.

11. The computer-implemented method of claim 10, wherein the two or more input data streams transmit information related to one or more devices in a data center.

12. The computer-implemented method of claim 10, wherein the one or more tasks comprise generating one or more predictions based, at least in part, on patterns identified using the at least one latent representation.

13. The computer-implemented method of claim 10, wherein the two or more input data streams comprise one or more of multimodal data, multivariate data, multicomponent data, or multisource data.

14. The computer-implemented method of claim 10, further comprising:
using self supervision to train the at least one neural network.

15. A system comprising:
one or more processors to at least:
use a plurality of machine learning processes arranged hierarchically to generate at least one latent representation of two or more input data streams; and
perform one or more tasks based, at least in part, on the at least one latent representation.

16. The system of claim 15, wherein the plurality of machine learning processes are to at least:
obtain a plurality of latent representations based at least in part on the two or more input data streams; and
align and merge at least two of the plurality of latent representations to generate the at least one latent representation.

17. The system of claim 15, wherein the one or more tasks comprise at least one of detecting one or more anomalies, predicting one or more future events, making one or more decisions, identifying at least one pattern in the two or more input data streams, classifying information, or performing regression.

18. The system of claim 15, wherein the two or more input data streams transmit information related to one or more devices in a data center.

19. The system of claim 18, wherein the two or more input data streams comprise at least one of multimodal data, multivariate data, multicomponent data, or multisource data.

20. The system of claim 15, wherein the plurality of machine learning processes are a first plurality of machine learning processes that define a first hierarchical structure, a second plurality of machine learning processes define a second hierarchical structure, a third plurality of machine learning processes define a third hierarchical structure, the third hierarchical structure to receive outputs of the first and second hierarchical structures as inputs, together the first, second, and third hierarchical structures forming at least part of a combined structure, the combined structure to be trained using at least one of supervised learning or unsupervised learning.
